(19) United States
(12) Patent Application Publication
(10) Pub. No.: US 2003/0124472 A1
(43) Pub. Date: Jul. 3, 2003

(54) Heat-developable photosensitive material and method of porducing the same

(76) Inventor: Soichiro Higashi, Shizuoka-ken (JP)

Correspondence Address: BIRCH STEWART KOLASCH & BIRCH, PO BOX 747, FALLS CHURCH, VA, 22040-0747, US

(21) Appl. No.: 10/254,868

(22) Filed: Sep. 26, 2002

(30) Foreign Application Priority Data
Sep. 26, 2001 (JP) 2001-294860

(51) Int. Cl. G03C 1/91

(52) U.S. Cl. 430/523; 430/619; 430/950

(57) ABSTRACT

The present invention provides a heat-developable photosensitive material comprising a support; an undercoat layer disposed on the support and formed in an atmosphere having a cleanliness class of no more than M5.45; and a photosensitive layer including silver behenate as a non-photosensitive organic silver salt and disposed on the undercoat layer, and a method of producing a heat-developable photosensitive material comprising the steps of: forming an undercoat layer by applying a coating liquid for the undercoat layer to a support and drying the liquid; forming a photosensitive layer by applying a coating liquid for the photosensitive layer, which coating liquid includes silver behenate, and drying the liquid; wherein the undercoat layer is formed in an atmosphere having a cleanliness class of no more than M5.45.

### BACKGROUND OF THE INVENTION

1. Field of the Invention

The present invention relates to a heat-developable photosensitive material, which may be referred to hereinafter as a “photosensitive material”, and a method of producing the same. Specifically, the invention relates to a high-quality heat-developable photosensitive material which is suitable for medical diagnosis, industrial photography, printing and COM, and neither has defects such as cissing or streaks resulting from dust in a processing atmosphere when an undercoat layer is formed on a support, nor has a defect of a black dot which is actualized when a photosensitive layer is formed; and a method of producing the same.

2. Description of the Related Art

In recent years, in the fields of film for medical diagnosis and film for photoengraving, there has been an intense demand reduce processing liquid waste from the viewpoints of environmental preservation and saving space. Thus, techniques relating to heat-developable photosensitive materials as film for medical diagnosis and film for photoengraving are required which can be effectively exposed to light with a laser image setter or a laser imager and can form distinct black images having a high resolution and sharpness. According to these heat-developable photosensitive materials, it is possible to supply customers with a simpler heat-developable processing system which does not require a processing chemical agent in a solution system or damage the environment.

Even in the fields of ordinary image forming materials, similar matters are demanded. However, particularly for images for medical diagnosis, a high image-quality, which is superior in sharpness and granularity, is necessary since delicate delineation is required. Moreover, blackness is preferable from the viewpoint of easier diagnosis. At present, various hard copy systems utilizing pigments or dyes, such as an inkjet printer and electrophotography, are in circulation for ordinary image forming systems. However, no hard copy system is satisfactory for an output system for medical images.

Thermal image forming systems utilizing an organic silver salt are described in, for example, U.S. Pat. (USP) Nos. 3,152,904 and 3,457,075, and Klosterboer, “Thermally Processed Silver Systems” (Imaging Processes and Materials), edited by J. Sturge, V. Walworth, and A. Shepp, Neblette 8th edition, chap. 9, p.279, 1989. Particularly a heat-developable photosensitive material in general contains a photosensitive layer wherein a catalyst-activating amount of a photocatalyst (for example, silver halide), a reducing agent, a reducible silver salt (for example, an organic silver salt), and an optional color adjuster for controlling a color tone of silver are dispersed in a matrix of a binder. The heat-developable photosensitive material is imagewise exposed to light, heated to a high temperature (for example, 80° C. or more) to cause a redox reaction between the reducible silver salt (functioning as an oxidizer) and the reducing agent, thereby forming a black silver image. The redox reaction is promoted by catalytic action of a latent image of the silver halide generated by the exposure. Therefore, the black and silver image is formed in the exposed area. Fuji Medical Dry Imager FM-DP L, which is disclosed in a great number of documents, examples of which include U.S. Pat. No. 2,910,377 and Japanese Patent Application Publication (JP-B) No. 43-4924, has been sold as a system for forming medical images using a heat-developable photosensitive material.

In the production process of the heat-developable photosensitive material, a photosensitive layer is formed on a support. At this time, an undercoat layer is frequently deposited on the support in order to raise the adhesiveness between the support and the photosensitive layer.

When the formation of the undercoat layer is performed in an atmosphere containing a large amount of dust, inconveniences such as a cissing defect or a streak defect, resulting from the dust, are generated in the undercoat layer so that a bad effect is transferred to the photosensitive formed thereon. On the basis of the dust in the undercoating step, a black spot defect is also generated right after the photosensitive layer is applied. Because of these defects, there arises a problem that faults occur in the heat-developable photosensitive material itself.

Particularly in the case in which the photosensitive layer contains silver behenate, there arises a problem that the above-mentioned inconveniences become apparent since the photosensitive layer is delicate.

### SUMMARY OF THE INVENTION

An object of the present invention is to solve the above-mentioned problems, namely to provide a high-quality heat-developable photosensitive material which neither has cissing or streak defects resulting from dust in a processing atmosphere when an undercoat layer is formed on a support, nor has a defect of a black dot, which is actualized when a photosensitive layer is formed; and a method of producing the same.

The invention for solving the above-mentioned problems is as follows.

A first aspect of the invention provides a heat-developable photosensitive material comprising a support; an undercoat layer disposed on the support and formed in an atmosphere having a cleanliness class of no more than M5.45; and a photosensitive layer including silver behenate as a non-photosensitive organic silver salt and disposed on the undercoat layer.

A second aspect of the invention provides the heat-developable photosensitive material, according to the first aspect, wherein the cleanliness class is no more than M5.25.

A third aspect of the invention provides the heat-developable photosensitive material, according to the first aspect, wherein the cleanliness class is no more than M5.15.

A fourth aspect of the invention provides the heat-developable photosensitive material, according to the first aspect, wherein the undercoat layer comprises a surface resistance (SR), the surface resistance being from 10⁶ to 10¹² Ω·cm.

A fifth aspect of the invention provides the heat-developable photosensitive material, according to the first aspect, wherein the undercoat layer includes at least one binder resin selected from the group consisting of acrylic resins, polyester resins, polyurethane resins, polystyrene resins, SBR resins and PVDC (polyvinyl dichloride) resins.

A sixth aspect of the invention provides the heat-developable photosensitive material, according to the first aspect, wherein the undercoat layer includes at least one conductive particle selected from the group consisting of tin oxide, indium oxide, zinc oxide, aluminum oxide and titanium oxide.

A seventh aspect of the invention provides the heat-developable photosensitive material, according to the sixth aspect, wherein the conductive particle comprises a conductive tin oxide particle doped with antimony having a needle-shaped structure including a long axis and a short axis, and a ratio of the long axis of the particle to the short axis ranges from 3 to 50.

An eighth aspect of the invention provides the heat-developable photosensitive material, according to the first aspect, wherein the undercoat layer includes at least one crosslinking agent selected from the group consisting of epoxy compounds, isocyanate compounds, melamine compounds, and active halogen compounds.

A ninth aspect of the invention provides the heat-developable photosensitive material, according to the first aspect, wherein the undercoat layer comprises at least one matting agent selected from the group consisting of styrene fine particles, polymethyl methacrylate fine particles, and silica fine particles, and the average particle diameter of the matting agent ranges from 0.1 to 8 μm.

A tenth aspect of the invention provides the heat-developable photosensitive material, according to the ninth aspect, wherein an amount of the matting agent used comprises from 1 to 200 mg per m² of the heat-developable photosensitive material.

An eleventh aspect of the invention provides the heat-developable photosensitive material, according to the first aspect, wherein the thickness of the undercoat layer comprises from 0.05 to 5 μm.

A twelfth aspect of the invention provides the heat-developable photosensitive material, according to the first aspect, wherein the photosensitive layer further includes a photosensitive silver halide, a non-photosensitive organic silver salt, a reducing agent for silver ions, and a binder.

A thirteenth aspect of the invention provides the heat-developable photosensitive material, according to the twelfth aspect, wherein the photosensitive silver halide includes at least one selected from the group consisting of silver chloride, silver chlorobromide, silver bromide, silver iodobromide, and silver iodochlorobromide.

A fourteenth aspect of the invention provides the heat-developable photosensitive material, according to the twelfth aspect, wherein a coated amount of the photosensitive silver halide, expressed as an amount of silver per m² of the heat-developable photosensitive material, comprises from 0.03 to 0.6 g/m².

A fifteenth aspect of the invention provides the heat-developable photosensitive material, according to the twelfth aspect, wherein the non-photosensitive organic silver salt includes not only the silver behenate but also at least one selected from the group consisting of silver arachidate, silver stearate, silver oleate, silver laurate, silver caprate, silver myristate, and silver palmitate.

A sixteenth aspect of the invention provides the heat-developable photosensitive material, according to the first aspect, wherein an amount of the silver behenate in the non-photosensitive organic silver salt in the photosensitive layer comprises at least 75% by mole.

A seventeenth aspect of the invention provides the heat-developable photosensitive material, according to the first aspect, wherein a total amount, as a silver amount, of the non-photosensitive organic silver salt used comprises from 0.1 to 5 g/m².

An eighteenth aspect of the invention provides the heat-developable photosensitive material, according to the twelfth aspect, wherein the reducing agent for the silver ions comprises at least one selected from hindered phenol-based reducing agents and bisphenol-based reducing agents.

A nineteenth aspect of the invention provides the heat-developable photosensitive material, according to the twelfth aspect, wherein an amount of the reducing agent for the silver ions added comprises from 0.01 to 5.0 g/m².

A twentieth aspect of the invention provides the heat-developable photosensitive material, according to the twelfth aspect, wherein the glass transition temperature of the binder comprises from 10° C. to 80° C.

A twenty-first aspect of the invention provides the heat-developable photosensitive material, according to the first aspect, further comprising a surface protecting layer and a back layer.

A first aspect of the invention provides a method of producing a heat-developable photosensitive material comprising the steps of: forming an undercoat layer by applying a coating liquid for the undercoat layer to a support and drying the liquid; forming a photosensitive layer by applying a coating liquid for the photosensitive layer, which coating liquid includes silver behenate, and drying the liquid; wherein the undercoat layer is formed in an atmosphere having a cleanliness class of no more than M5.45.

A second aspect of the invention provides the method of producing a heat-developable photosensitive material according to the first aspect, wherein the coating liquid for the undercoat layer comprises an aqueous coating liquid including at least one of a solvent comprising at least 30% by mass of water and a dispersing medium comprising at least 30% by mass of water.

A third aspect of the invention provides the method of producing a heat-developable photosensitive material according to the first aspect, wherein in the undercoat layer forming step, after the coating liquid for the undercoat layer is applied, the liquid is dried at a temperature of 25 to 200° C. for 0.5 to 20 minutes.

### DESCRIPTION OF THE PREFERRED EMBODIMENTS

A heat-developable photosensitive material of the present invention and a method of producing the same will be described in detail hereinafter.

The heat-developable photosensitive material of the invention comprises, a support, an undercoat layer disposed on the support and formed in an atmosphere having a cleanliness class of no more than M5.45 and a photosensitive layer including silver behenate as a non-photosensitive organic silver salt and disposed on the undercoat layer.

Furthermore, the method of producing a heat-developable photosensitive material of the invention comprises the steps of forming an undercoat layer by applying a coating liquid for the undercoat layer to a support and drying the liquid, forming a photosensitive layer by applying a coating liquid for the photosensitive layer, which coating liquid includes silver behenate, and drying the liquid, wherein the undercoat layer is formed in an atmosphere having a cleanliness class of no more than M5.45.

Here, the undercoat layer will be explained.

Undercoat Layer

The undercoat layer according to the invention as described above, is an undercoat layer formed in an atmosphere having a cleanliness class of no more than M5.45.

The cleanliness class is a standard relating to cleanliness, which stipulated in FED-STD-209E. When a number, per m³, of floating particles present in the atmosphere and having a particle diameter of 0.5 μm or more is represented by 10^{X}, the above cleanliness class is the value of X. Since the above cleanliness class is based on the metric system, the class is represented by M (X).

The cleanliness can also be represented as a value based on feet (FED-STD-209D). M4.5 is converted to class 1,000 (that is, the number of floating particles having a particle diameter of 0.5 μm or more is 1,000 per ft³), and M5.5 is converted to class 10,000 (that is, the number of floating particles having a particle diameter of 0.5 μm or more is 10,000 per ft³ (10000/CFM)).

The undercoat layer of the invention is formed by applying a coating liquid for the undercoat layer to a support and drying the applied liquid. The undercoat layer is formed in an atmosphere having a cleanliness class of no more than M5.45 (the number of floating particles having a particle diameter of 0.5 μm or more is 8,000/ft³, or less, that is, class 8000, or less). The undercoat layer is formed preferably in an atmosphere having a cleanliness class of no more than M5.25 (the number of floating particles having a particle diameter of 0.5 μm or more is 5,000/ft³, or less, that is, class 5000, or less), more preferably in an atmosphere having a cleanliness class of no more than M5.15 (the number of floating particles having a particle diameter of 0.5 μm or more is 4,000/ft³, or less, that is, class 4000, or less).

If the value of the cleanliness class is more than M5.45 (class 8000), floating particles, dust, and the like, which are present in the atmosphere, frequently result in the following defects in the undercoat layer: a cissing defect (meaning an inconvenience wherein the dust adhere to the undercoat layer so that the layer becomes uneven and pitting appears), a streak defect (meaning an inconvenience wherein the thickness of the layer is made non-uniform by a bad effect of the dust when the layer is formed, so that fines streaks are continuously formed), and a black dot defect (meaning an inconvenience wherein the dust and dust adhering to the surface of the undercoat layer when being formed is taken in a photosensitive layer when being formed, so that a visible black spot, whose density is higher than that of normal portions, is formed). Thus, such a case is unfavorable.

As a way for measuring the cleanliness class, a dust measuring device (made by Hiack/Leuco in USA) exclusively for a clean room is used to count, with a semiconductor laser, different sizes of particles in a specified amount (1 ft³) of absorbed air, and on the basis of the results the cleanliness class is represented according to the FED-STD.

The step of forming the undercoat layer (the first step) includes a whole series of processes: an interval before the undercoat layer coating liquid is applied to the support, an interval while the undercoat layer coating liquid is applied to the support, an interval while the undercoat layer coating liquid is dried after the liquid has been applied to the support, and an interval from the time when the undercoat layer coating liquid is dried to form the undercoat layer to the time immediately before the step of forming a photosensitive layer (the second step). It is preferable that the cleanliness class of the atmosphere is kept within the above-mentioned range in the whole series of processes.

In order to keep the cleanliness class within the above-mentioned range, it is also preferable to perform the first step in a casing.

The second step will be described in the explanation on the photosensitive layer, which will be given later.

The undercoat layer according to the invention may contain a water-dispersible resin as a binder resin. Examples of a water-dispersible resin include acrylic resins, polyester resins, polyurethane resins, polystyrene resins, SBR resins and PVDC resins. These resins have a high water-resistance, and good adhesiveness to a polyester film or the like.

If necessary, a polymer other than the binder is blended into the undercoat layer. The kind of the polymer is not particularly limited, and examples thereof include water-soluble polymers, such as gelatin and polyvinyl alcohol, and hydrophobic polymers, such as vinylidene chloride and polyurethane.

If necessary, the following besides the binder may be added to the undercoat layer according to the invention, electroconductive particles, a crosslinking agent, a matting agent, a dye, a filler, a surfactant, an antiseptic, a pH adjuster or the like.

The undercoat layer according to the invention is preferably a layer having a surface resistance (SR) of from 10⁶ to 10¹² Ω·cm. By setting the surface resistance of the undercoat layer within the above-mentioned range, an electrostatic trouble at the time of processing is improved so that fog can be effectively prevented. In order to set the surface resistance within the above-mentioned range, it is preferable to add electroconductive particles to the undercoat layer.

Examples of the kind of the electroconductive particles include tin oxide, indium oxide, zinc oxide, aluminum oxide, and titanium oxide. Tin oxide doped with antimony is preferable, and antimony-doped electroconductive tin oxide particles having a needle-shaped structure, and a ratio of a long axis to a short axis is within the range of from 3 to 50, is particularly preferable. When the electroconductive tin oxide particles having a needle structure is used, by adding a small amount thereof, it possible to obtain a necessary conductivity. Therefore, the following problem can be avoided: the undercoat layer exhibits blueness, which is the color of tin oxide, so that Dmix becomes high (the color of the surface becomes dull) and photographic image performance deteriorates.

As the crosslinking agent, a known compound such as epoxy, isocyanate or melamine is used. It is preferable to use an active halogen crosslinking agent described in Japanese Patent Application Laid-Open (JP-A) No. 51-114120 and the like.

In order to make high-speed conveyance characteristics in the production good, it is preferable to use a matting agent in the undercoat layer. It is preferable to use, as the matting agent, fine particles of styrene, polymethyl acrylate, or silica having an average particle diameter of about 0.1 to 8 μm, and preferably of about 0.2 to 5 μm. The amount of the matting agent used is preferably from 1 to 200 mg, and more preferably from 2 to 100 mg per m² of the heat-developable photosensitive material.

As the filler, colloidal silica or the like may be used. As the surfactant, an anionic, nonionic or cationic surfactants may be used. As the dye, a dye for anti-halation, a dye for color tone adjustment or the like may be used.

The thickness of the undercoat layer or each of the undercoat layers is preferably from about 0.05 to 5 μm, and more preferably from about 0.1 to 3 μm.

The undercoat may be formed by applying and drying an aqueous or organic-solvent coating liquid for the undercoat layer. However, from the viewpoints of cost and environmental preservation, it is preferable to use the aqueous coating liquid. The wording “aqueous coating liquid” herein means a coating liquid whose solvent (medium) contains water in an amount of 30% or more, and preferably 50% by mass or more.

Specific examples of the composition of the solvent include the following: water/methanol=85/15, water/methanol=70/30, water/methanol/dimethylformamide (DMF)=80/15/5, and water/isopropyl alcohol=60/40 (the numbers represent ratios by mass), and water itself.

The coating method and the drying method of the undercoat layer of the invention are not particularly limited if the methods are performed in an atmosphere having a cleanliness class within the above-mentioned range.

As the coating method, a known method such as a bar coater method or a dip coater method may be used.

The drying method may be performed at a temperature of about 25 to 200° C. for about 0.5 to 20 minutes. Under these conditions, the coating liquid can be dried.

The undercoat layer according to the invention may comprise mono layer or two or more layers.

Photosensitive Layer

The following will describe the photosensitive layer, which may be referred to as an “image-forming layer” hereinafter, in the invention.

The photosensitive layer in the invention includes silver behenate as a non-photosensitive organic silver salt. It is preferable that the photosensitive layer includes a photosensitive silver halide, some other non-photosensitive organic silver salt, a reducing agent for silver ions, and a binder if necessary.

The components contained in the photosensitive layer in the invention will be described hereinafter.

The halogen composition of the photosensitive silver halide is not particularly limited. Silver chloride, silver chlorobromide, silver bromide, silver iodobromide, or silver iodochlorobromide may be used. Of these, silver bromide and silver iodobromide are preferable. The distribution of the halogen in the grains may be even, may be changed step by step, or may be continuously changed. Silver halide grains having a core/shell structure can be preferably used. The structure thereof preferably has one selected from a double structure to a quintuple structure. More preferably, core/shell grains having a structure selected from a double structure to a quadruplet structure are used. It is also preferable to use technique of localizing silver bromide onto the surface of silver chloride or silver chlorobromide grains.

Methods of forming a photosensitive silver halide are well-known by those skilled in the art. For example, the methods described in the following can be used: Research Disclosure No. 17029, June, 1978, and U.S. Pat. No. 3,700,458. Specifically, the following method is used: a photosensitive silver halide is prepared by adding a silver-supplying compound and a halogen-supplying compound to a solution of gelatin or some other polymer, and subsequently the solution is mixed with an organic silver salt. Methods described in pars. 0217 to 0224 of JP-A No. 11-1192374, and Japanese Patent Application Nos. 11-98708 and 2000-42336 are also preferable.

In order to suppress cloudiness after the formation of an image, a grain size of the photosensitive material is preferably small and is specifically 0.20 μm or less, more preferably from 0.01 μm to 0.15 μm, and most preferably from 0.02 to 0.12 μm. The grain size herein denotes a diameter of a circular image having an area equivalent to a projected area of the silver halide grain (the projected area of a main plane in the case of tabular grains).

Examples of the silver halide grain include cubic, octahedral, tabular, spherical, rod-like and potato-shaped grains. In the invention, cubic grains are particularly preferable. Silver halide grains whose corners are round can also be preferably used. The plane index (Miller index) of the outer surface of the photosensitive silver halide grains is not particularly limited, but it is preferable that the ratio of the {1 0 0} plane, which has a high spectrally sensitizing efficiency in the case in which a spectrally sensitizing dye is adsorbed, is high. this ratio is preferably 50% or more, more preferably 65% or more, and further preferably 80% or more. The ratio of the Miller index {1 0 0} plane can be obtained by a method described in “J. Imaging Sci., 29, 165 (1985)” by T. Tani, using adsorption dependency of {1 1 1} and {1 0 0} planes in adsorption of sensitizing dyes.

In the invention, silver halide grains wherein a hexacyano metal complex is caused to be present in an outermost surfaces of the silver halide grains are preferable. Examples of the hexacyano metal complex include [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻ and [Re(CN)₆]³⁻. In the invention, hexacyano iron complexes are preferable.

Since the hexacyano metal complex is present in the form of an ion in an aqueous solution, a counter cation thereof is not important, but any one selected from the following ions, which are easily miscible with water and suitable for precipitation operation of an silver halide emulsion, is preferably used: alkali metal ions (such as sodium, potassium, rubidium, cesium, and lithium ions), an ammonium ion, and alkyl ammonium ions (such as tetramethyl ammonium, tetraethyl ammonium, tetrapropyl ammonium and tetra(n-butyl)ammonium ions).

The tetracyano metal complex may be added in the form of a mixture of the complex and a mixed solvent of water and a suitable solvent which is miscible with water (for example, any one selected from alcohols, ethers, glycols, ketones, esters and amides), as well as in the form of the complex mixed with water, or in the form of the complex mixed with gelatin.

An amount of the tetracyano metal complex to be added is preferably from 1×10⁻⁵ to 1×10⁻² moles, preferably from 1×10⁻⁴ to 1×10⁻³ moles per mole of silver.

In order to cause the tetracyano metal complex to be present on the outermost surface of the silver halide grains, the tetracyano metal complex is directly added after the addition of an aqueous solution of silver nitrate, which is used for the formation of the grains, and before the end of a charging step before a chemical sensitization step of performing calcogen sensitization, such as sulfur sensitization, selenium sensitization or tellurium sensitization, or noble metal sensitization, such as gold sensitization, or is directly added in a water-washing step, in a dispersing step, or before the chemically sensitizing step. In order to cause the silver halide fine grains not to grow, it is preferable to add the tetracyano metal complex rapidly after the formation of the grains and before the end of the charging step.

The addition of the tetracyano metal complex may be initiated after 96% by mass of the total amount of silver nitrate, which is added to form the grains, is added. The addition is preferably initiated after 98% by mass thereof is added, and is particularly preferably started after 99% by mass thereof is added.

If the tetracyano metal complex is added after the aqueous solution of silver nitrate is added (that is, immediately before the completion of the formation of the grains), the complex can be adsorbed on the outermost surface of the silver halide grains, and almost all of the grains are combined with silver ions on the surfaces of the grains to form a slightly water-soluble salt. Since the silver salt of the tetracyano iron (II) is a salt which is a less water-soluble salt than AgI, re-dissolution based on the fine grains can be prevented. Thus, silver halide fine grains having a small grain size can be produced.

The photosensitive silver halide grains in the invention can contain a metal of the VIII group to the X group in the periodic table (describing the I group to XVIII group), or a complex of the metal. The metal of the VIII group to the X group in the periodic table, or the central metal of the metal complex is preferably rhodium, ruthenium, or iridium. A single kind of these metal complexes may be used, or two or more kinds of the complexes of the same metal or different metals may be used. A preferred content of the metal or the metal complex is preferably within the range of 1×10⁻⁹ to 1×10⁻³ per mole of silver. The heavy metals, the metal complexes and the method of the addition thereof are described in JP-A No. 7-225449, pars. 0018 to 0024 of JP-A No. 11-65021, and pars. 0227 to 0240 of JP-A No. 11-119374.

The metal atoms which can be contained in the silver halide grains used in the invention (for example, [Fe(CN)₆]⁴⁻)), the method of desalting a silver halide emulsion, and the method of chemically sensitizing the emulsion are described in pars. 0046 to 0050 of JP-A No. 11-84574, pars. 0025 to 0031 of JP-A No. 11-65021, and pars. 0242 to 0250 of JP-A No. 11-119374.

The gelatin contained in the photosensitive silver halide emulsion that is used in the invention may be any one selected from various gelatins. In order to keep the dispersion state of the photosensitive silver halide emulsion in the organic silver salt-containing coating liquid good, it is preferable to use a low molecular weight gelatin having a molecular weight of 500 to 60,000. The low molecular weight gelatin may be used at the time of the formation of the grains, or the time the dispersion the grains after desalting treatment, but the latter time is preferable.

A sensitizing dye which can be used in the invention can be profitably selected from sensitizing dyes that have a spectral sensitivity suitable for the spectral property of a light source for exposure and can spectrally sensitize silver halide grains in a desired wavelength range when the dyes are absorbed on the silver halide grains. The sensitizing dyes and methods of adding the same are described in pars. 0103 to 0109 of JP-A No. 11-65021, JP-A No. 10-186572 (compounds represented by the general formula (II)), JP-A No. 11-119374 (dyes represented by the general formula (I), and pars. 0106), U.S. Pat. Nos. 5,510,236, 3,871,887 (dyes described in Example 5), JP-A Nos. 2-96131 (dyes), 59-48753 (dyes), EP No. 0803764A1 (page 19, line 38 to page 20, line 35), Japanese Patent Application Nos. 2000-86865, 2000-102560 and 2000-205399. These sensitizing dyes may be used alone or in combinations of two or more. The time period during which the sensitizing dye is added to the silver halide emulsion in the invention is preferably after the desalting step and before the step of applying the emulsion, and is more preferably after the desalting step and before the start of chemical ripening.

An amount of the sensitizing dye added may be a desired amount corresponding to sensitivity and performance against fog. The amount is preferably from 10⁻⁶ to 1 mole, and more preferably from 10⁻⁴ to 10⁻¹ mole per mole of silver halide in the photosensitive layer.

In order to improve the spectrally sensitizing efficiency in the invention, a supersensitizer may be used. Examples thereof include compounds described in EP No. 587,338A, U.S. Pat. Nos. 3,877,943, 4,873,184, JP-A Nos. 5-341432, 11-109547, and 10-111543.

The photosensitive silver halide grains are preferably subjected to chemical sensitization by a sulfur sensitizing method, a selenium sensitizing method or a tellurium sensitizing method. A compound which is preferably used in the sulfur sensitizing method, the selenium sensitizing method or the tellurium sensitizing method may be a known compound, such as any one of compounds described in JP-A No. 7-128768. In the invention, the tellurium sensitization is particularly preferable. Compounds described in par. 0030 of JP-A No. 11-65021, and compounds represented by the general formulae (II), (III), and (IV) in JP-A No. 5-313284 are more preferable.

In the invention, chemical sensitization may be performed at any time after the formation of the grains and before the coating with the emulsion, for example, after the desalting step and (1) before the spectral sensitization, (2) at the same time when the spectral sensitization is performed, and (3) after the spectral sensitization, (4) immediately before the coating with the emulsion. The chemical sensitization is preferably performed after the spectral sensitization.

The amount of the sulfur, selenium or tellurium sensitizer used in the invention varies dependently on the used silver halide grains, chemically ripening conditions, and the like. The amount is from about 10⁻⁸ to 10⁻² mole, and preferably from about 10⁻⁷ to 10⁻³ mole per mole of silver halide. Conditions for the chemical sensitization in the invention are not particularly limited. The pH is from 5 to 8, pAg is from 6 to 11, and temperature is from about 40 to 95° C.

A thiosulfonic acid compound may be added to the silver halide emulsion used in the invention by a method described in EP-A No. 293,917.

The photosensitive silver halide emulsions in the photosensitive material used in the invention may be used alone or in combinations of two or more (for example, emulsions having different average grain sizes, emulsions having different halogen compositions, emulsions having different crystal habits, and emulsions subjected to chemical sensitizations under different conditions). Two or more photosensitive silver halides having different sensitivities are used to make it possible to adjust color tones. Examples of the technique thereon are disclosed in JP-A Nos. 57-119341, 53-106125, 47-3929, 48-55730, 46-5187, 50-73627, and 57-150841. It is preferable to cause the emulsions to have a sensitivity difference of 0.2 logE or more between them.

The addition amount of the photosensitive silver halide is preferably from 0.03 to 0.6 m/m², more preferably from 0.04 to 0.4 g/m², and most preferably from 0.05 to 0.3 g/m², as an amount of applied silver per m² of the photosensitive material. The amount of the photosensitive silver halide is preferably from 0.01 to 0.5 mole, and more preferably from 0.02 to 0.3 mole per mole of the organic silver salt.

Examples of the method of mixing the photosensitive silver halide and the organic silver salt which are separately prepared and conditions for the mixing include a method of mixing the silver halide grains and the organic silver salt, each of which has already been prepared, with a high-speed stirrer, a ball mill, a sand mill, a colloid mill, a vibration mill, a homogenizer, or the like; and a method of mixing with the photosensitive silver halide, which has already been prepared, at any time while the organic salt is being prepared, so as to prepare the organic silver salt. If the effect of the invention is sufficiently produced, the method to be used is not limited. At the time of the mixing, it is preferable to mix two or more organic silver salt dispersed aqueous-liquids and two or more photosensitive silver salt dispersed aqueous-liquids for the adjustment of photographic properties.

A preferable time for adding the silver halide to the image forming layer coating liquid in the invention is from a time of 180 minutes before the coating with the liquid to a time immediately before the coating, and preferably from a time of 60 minutes before the coating to a time of 10 seconds before the coating. The method of mixing the silver halide with the liquid and conditions of the mixing are not particularly limited if the effect of the invention is sufficiently produced. Specific examples of the mixing method include a method of mixing in a tank wherein an average remaining time, which is calculated from an addition flow rate and an amount of a liquid sent to a coater, is set to a desired time, and a method of using a static mixer, described in N. Harnby, M. F. Edwards and A. W. Nienow, translated by Koji Takahashi, “Liquid Mixing Technique”, The Nikkann Kogyo Shimbun, Ltd. 1989, Chapter 8.

The photosensitive layer according to the invention contains silver behenate as a non-photosensitive organic silver salt, and can contain, if necessary, other non-photosensitive organic silver salts.

The non-photosensitive organic silver salt that can be used in the invention, which may be referred to merely as the “organic silver salt” hereinafter, is a silver salt which is relatively stable against light and which produces a silver image when it is heated to 80° C. or more in the presence of an exposed photocatalyst (such as a latent image of the photosensitive silver halide) and a reducing agent. The organic silver salt may be any organic material containing a source capable of reducing silver ions. Such a non-photosensitive organic silver salt is described in JP-A Nos. 06-130543, 08-314078, 09-127643, 10-62899 (pars. 0048 to 0049), JP-A Nos. 10-94074, 10-94075, EP No. 0803764A1 (page 18, line 24 to page 19, line 37), EP Nos. 0962812A1, 1004930A2, JP-A Nos. 11-349591, 2000-7683, 2000-72711, 2000-112057, 2000-155383, and the like. A silver salt of an organic acid is preferable, and a silver salt of a long-chain aliphatic carboxylic acid (having 10 to 30 carbon atoms, preferably 15 to 28 carbon atoms) is particularly preferable. Preferable examples of the organic silver salt include silver behenate, silver arachidate, silver stearate, silver oleate, silver laurate, silver caprate, silver myristate, silver palmitate, and mixtures thereof. The photosensitive layer according to the invention contains silver behenate, and it is preferable to use an organic acid silver having a silver behenate content of 75% by mole or more.

The shape of the organic silver salt which can be used in the invention is not particularly limited, and may be a needle shape, a rod shape, a tabular shape or a scale shape.

In the invention, a scale-shaped organic silver salt is preferable. In the present specification, the scale-shaped organic silver salt is defined as follows. An organic silver salt is observed with an electron microscope, and the shape of the organic silver salt grain is approximated to a rectangular parallelepiped. When the sides of the rectangular parallelepiped are represented in order from the shortest side by a, b and c (c may be equal to b), the values a and b, which are the shortest and the second shortest, respectively, are used to calculate x as follows.

X=b/a

In this way, x is calculated for each of about 200 grains. When the average value thereof is represented by x (average), the grains satisfying the relationship of x (average)≧1.5 are defined as scale-shaped grains. Preferably, 30≧x (average)≧1.5, and more preferably 20≧x(average)≧2.0. Needle-shaped grains satisfy 1≦x (average)<1.5.

In the scaly grain, the value a can be regarded as a thickness of a tabular grain having, as a main plane, a face having sides a and b. The average of a is preferably from 0.01 to 0.23 μm, more preferably from 0.1 to 0.20 μm. The average of c/b is preferably from 1 to 6, more preferably from 1.05 to 4, more still preferably from 1.1 to 3, and most preferably from 1.1 to 2.

The grain size distribution of the organic silver salt is preferably monodisperse. In monodispersion, the percentages resulting from values obtained by dividing the standard deviations of lengths of short axes and long axes by the lengths of the short axes and long axes, respectively, are preferably 100% or less, more preferably 80% or less, and most preferably 50% or less. The shape of the organic silver salt can be measured from a transmission electron microscopic image of a dispersion of the organic silver salt. Another method of measuring mono-dispersibility is a method of obtaining the standard deviation of the volume weighted average diameter of the organic silver salt grains. A percentage (variation coefficient) resulting from the value obtained by dividing the standard deviation by the volume weighted average diameter is preferably 100% or less, more preferably 80% or less, and most preferably 50% or less. The variation coefficient can be calculated, for example, from the grain size (volume weighted average diameter) obtained by applying a laser ray to the organic silver salt dispersed in the liquid and obtaining a self-correlation function for a time change in fluctuation of light scattered from the salt.

As the production of the organic silver salt used in the invention and the method of dispersing the salt, known methods may be used. Examples thereof include JP-A Nos. 08-234358, 10-62899, EP Nos. 0803763A1, 0962812A1, JP-A Nos. 11-349591, 2000-7683, 2000-72711, 2000-53682, 2000-75437, 2000-86669, 2000-143578, 2000-178278, 2000-256254, and Japanese Patent Application Nos. 11-348228 to 11-348230, 11-203413, 11-115457, 11-180369, 11-297964, 11-157838, 11-202081, 2000-90093, 2000-195621, 2000-191226, 2000-213813, 2000-214155, and 2000-191226.

If the photosensitive silver salt is caused to coexist with the organic silver salt at the time of dispersing the organic silver salt, fog increases and sensitivity falls markedly. Therefore, it is preferable that the photosensitive silver salt is substantially not contained at the time of the dispersing. In the invention, the amount of the photosensitive silver salt in the aqueous liquid for dispersion is 0.1 mole % or less per mole of the organic silver salt in the liquid. The addition of a positive photosensitive silver salt is not positively conducted.

In the invention, the photosensitive material can be produced by blending the organic silver salt dispersed aqueous-liquid with the photosensitive silver salt dispersed aqueous-liquid. However, the blend ratio between the organic silver salt and the photosensitive silver salt can be selected dependently on a purpose. The ratio of the photosensitive silver salt to the organic silver salt is preferably within the range of 1 to 30% by mole, more preferably within the range of 3 to 20% by mole, and most preferably within the range of 5 to 15% by mole. In the case of a mixture it is preferable for the adjustment of photographic properties to blend two or more organic silver salt dispersed aqueous-liquids with two or more photosensitive silver salt dispersed aqueous-liquids.

The organic silver salt may be used in a desired amount in the invention. The amount of silver is preferably from 0.1 to 5 g/m² and more preferably from 1 to 3 g/m².

The heat-developable photosensitive material of the invention preferably contains a reducing agent for the organic silver salt. The reducing agent for the organic silver salt may be any material (preferably an organic material) capable of reducing a silver ion to metal silver. This reducing agent is described in JP-A No. 11-65021 (pars. 0043 to 0045) and EP No. 0803764A1 (page 7, line 34 to page 18, line 12).

In the invention, preferable examples of the reducing agent include hindered phenol reducing agents, and bisphenol reducing agents. Compounds represented by the general formula (I) described in Japanese Patent Application No. 2000-358846 are more preferable.

Specific examples of the reducing agent preferably used in the invention include reducing agents described in Japanese Patent Application No. 2000-358846.

The amount of the reducing agent added is preferably from 0.01 to 5.0 g/m² and more preferably from 0.1 to 3.0 g/m². Preferably, 5 to 50% by mole of the reducing agent is contained per mole of silver in the face having the photosensitive layer, and more preferably 10 to 40% by mole of the agent is contained per mole of the silver. The reducing agent is preferably contained in the image forming layer.

The reducing agent may be incorporated into the coating liquid in any manner, such as in a solution, in an emulsion/dispersion, or in a solid fine grain dispersion, so as to be incorporated into the photosensitive material.

A well-known example of the emulsion/dispersion manner is a manner of using an oil such as dibutyl phthalate, tricresyl phosphate, glyceryl triacetate or diethyl phthalate, or a co-solvent such as ethyl acetate or cyclohexanone to dissolve the reducing agent, and producing an emulsified/dispersed product mechanically.

An example of the solid fine grain dispersing manner is a manner of dispersing a powder of the reducing agent into a suitable solvent such as water with a ball mill, a colloid mill, a vibration mill, a sand mill, a jet mill or a roller mill, or by ultrasonic waves, so as to produce a solid dispersed product. At this time, a protective colloid (for example, polyvinyl alcohol), or a surfactant may be used (for example, an anionic surfactant such as sodium triisopropylnaphthalenesulfonate (a mixture of the compounds having three isopropyl groups at different substitution positions)). An antiseptic (for example, a sodium salt of benzoisothiazolinone) may be incorporated into the aqueous dispersed product.

In the heat-developable photosensitive material of the invention, a phenol derivative represented by the formula (A) described in Japanese Patent Application No. 11-73951 can be preferably used as a development accelerator.

In the case in which the reducing agent in the invention has an aromatic hydroxyl group (—OH), particularly in the case of any one of the above-mentioned bisphenols, it is preferable to use, together with the reducing agent, a non-reducing compound having a group which can be combined with the hydroxyl group to form a hydrogen bond. Examples of the group which is combined with the hydroxyl group or an amino group to form a hydrogen bond include phospholyl, sulfoxide, sulfonyl, carbonyl, amide, ester, urethane, ureido, tertiary amino, and nitrogen-containing aromatic groups. Among these groups, phospholyl, sulfoxide, amide (provided that the amide has no >N—H group and is blocked as >N—Ra wherein Ra is a substituent other than H), urethane (provided that the urethane has no >N—H group and is blocked as >N—Ra wherein Ra is a substituent other than H), and ureido (provided that the ureido has no >N—H group and is blocked as >N—Ra wherein Ra is a substituent other than H) are preferable.

In the invention, a particularly preferable compound having hydrogen bonding ability (i.e., hydrogen bonding compound) is a compound represented by the general formula (II) described in Japanese Patent Application No. 2000-358846.

Specific examples of the hydrogen bonding compound include compounds described in Japanese Patent Application No. 2000-358846, and compounds described in Japanese Patent Application Nos. 2000-192191 and 2000-194811.

The compound represented by the general formula (II) described in Japanese Patent Application No. 2000-358846, which is used in the invention, may incorporated into the coating liquid in the same way as for the reducing agent, that is, in a solution form, an emulsion/dispersion form, or a solid fine grain dispersed product form, whereby the compound can be used in the photosensitive material. The above-mentioned compound in a solution state is combined with a compound having a phenolic hydroxyl group or an amino group to form a hydrogen bonding complex. Depending on the kind of the combination of the reducing agent with the compound represented by the above-mentioned general formula (II), the complex can be isolated in a crystal state. In order to gain stable performance, it is particularly preferable to use the thus-isolated crystal powder as a solid fine grain dispersed product. It is also preferable to use a method of mixing the reducing agent with the compound represented by the general formula (II) in a powdery form, and using an appropriate dispersing agent to form a complex at the time of dispersing the mixture with a sand grinder mill or the like.

The amount of the compound, which is represented by the general formula (II), used is preferably from 1 to 200% by mole of the reducing agent, more preferably from 10 to 150% by mole thereof, and most preferably from 30 to 100% by mole thereof.

A binder in the organic silver salt-containing layer (photosensitive layer) in the invention may be any polymer, and a preferable binder is a binder made of a transparent or semitransparent, colorless, natural or synthetic polymer or copolymer (i.e., resin), or some other medium which can make into a film. Examples thereof include gelatins, rubbers, poly(vinylalcohols), hydroxyethylcelluloses, cellulose acetates, cellulose acetate butylates, poly(vinylpyrrolidone), gasein, starch, poly(acrylates), poly(methylmethacrylic acids), poly(vinylchlorides), poly(methacrylic acids), styrene-maleic anhydride copolymers, styrene-acrylonitrile copolymers, styrene-butadiene copolymers, poly(vinylacetals) such as poly(vinylformal) and poly(vinylbutyral), poly(esters), poly(urethanes), phenoxy resin, poly(vinylidene chlorides), poly(epoxides), poly(carbonates), poly(vinyl acetates), poly(olefins), cellulose esters, and poly(amides). The binder may be formed into a coat from an aqueous solution, an organic solvent or from an emulsion.

In the invention, it is preferable that the glass transition temperature of the binder in the organic silver salt-containing layer (photosensitive layer) is from 10 to 80° C. This binder may be referred to as a high Tg binder hereinafter. The glass transition temperature is more preferably from 20 to 70° C., and most preferably from 23 to 65° C.

In the present specification, Tg of a polymer is calculated from the following equation:

1/Tg=Σ(Xi/Tgi)

In the polymer, n (i=1 to n) monomer components are copolymerized. Xi represents the weight fraction of the i^{th} monomer (ΣXi=1). Tgi represents the glass transition temperature (absolute temperature) of a homopolymer of the i^{th} monomer. The symbol Σ is a sum total of components of i=1 to n. As the value (Tgi) of the glass transition temperature of the homopolymer of each of the monomers, the values described in J. Brandrup and E. H. Immergut Wiley-Interscience, 1989, “Polymer Handbook (3^{rd} edition)” are adopted.

The polymers, each of which will be the binder, may be used alone, or may be, if necessary, used in combination of two or more kinds of thereof. A combination of the polymer having a glass transition temperature of 20° C. or more with the polymer having a glass transition temperature below 20° C. may be used. In the case in which two or more polymers having different Tg's are blended, it is preferable that the weight-average Tg thereof be within the above-mentioned range.

In the invention, the performance thereof is improved in the case in which the coating liquid wherein its solvent contains 30% or more by weight of water is applied and dried to form the organic silver salt-containing layer (photosensitive layer) and in the case in which the binder in the organic silver salt-containing layer (photosensitive layer) is soluble or dispersible in an aqueous solvent (water solvent), particularly in the case in which the binder is made of a latex of a polymer whose equilibrium water content at 25° C. and 60% RH is 2% by mass or less. The most preferable form is a binder prepared so as to have an ion conductivity of 2.5 mS/cm or less. An example of the method of preparing this binder is a method of synthesizing a polymer and subsequently using a separation function membrane to purify the polymer.

The above-mentioned aqueous solvent in which the polymer is soluble or dispersible is water, or a mixture of water and 70% by mass or less of an organic solvent that is miscible with water. Examples of the organic solvent miscible with water include alcohols such as methyl alcohol, ethyl alcohol, and propyl alcohol; cellosolves such as methylcellosolve, ethylcellosolve and butylcellosolve; ethyl acetate; and dimethylformamide.

A system in which the polymer is not thermodynamically dissolved but is dispersed is also included in the category of the aqueous solvent.

The words “equilibrium water content at 25° C. and 60% RH” can be calculated as follows: using the weight W₁ of a polymer which is at a humidity conditioning equilibrium under an atmosphere of 25° C. and 60% RH and the weight W₀ of the polymer which is in an absolutely dry state at 25° C.:

equilibrium water content at 25° C. and 60% RH={(W₁-W₀)/W₀}×100 (% by mass)

The following can be referred to regarding the definition of the water content and a measurement method thereof. For example, the Society of Polymer Science, Japan, “Macromolecular Material Testing Methods”, Koubunshi Kougaku Kouza 14, published by Chijin Syokan.

The equilibrium water content at 25° C. and 60% RH of the binder polymer in the organic silver salt-containing layer (photosensitive layer) in the invention is preferably 2% by mass or less, more preferably from 0.01 to 1.5% by mass, and most preferably from 0.02 to 1% by mass.

In the invention, the polymer dispersible in the aqueous solvent is particularly preferable. Examples of the dispersed product include a latex in which fine particles of a hydrophobic polymer, which is insoluble in water, are dispersed, and a product in which polymer molecules are dispersed in a molecular state or in a micelle state. These examples are preferable. The average particle diameter of the dispersed particles is from about 1 to 50,000 nm, more preferably from about 5 to 1,000 nm. The particle diameter distribution of the dispersed particles is not particularly limited, and may be a broad particle diameter distribution or a mono-dispersive distribution.

Preferable examples of the polymer dispersible in the aqueous solvent include hydrophobic polymers such as acrylic polymers, poly(esters), rubbers (for example, SBR resin), poly(urethanes), poly(vinyl chlorides), poly(vinyl acetates), poly(vinylidene chlorides), and poly(olefins). These polymers may be straight-chain polymers, branched polymers, or crosslinked polymers. These polymers may be the so-called homopolymers, each of which is produced by polymerizing a single kind of monomer, or copolymers, each of which is produced by polymerizing two or more kinds of monomers. In the case of the copolymer, the copolymer may be a random copolymer or a block copolymer. The number-average molecular weight of these polymers is from 5,000 to 1,000,000, preferably from 10,000 to 200000. If the molecular weight is too small, the dynamic strength of the emulsion layer is insufficient. If the molecular weight is too large, the film-forming ability is poor.

Preferable specific examples of the polymer latex include the following. The examples are represented by component monomers, and numerical values in parentheses represent percentages by mass (% by mass). Molecular weights in parentheses denote number-average molecular weight. In the case in which a polyfunctional monomer is used, the concept of any molecular weight cannot be used since the monomer will make a crosslink structure. Therefore, about such a polymer, the word “crosslinking” is described and description on any molecular weight is omitted. Tg denotes glass transition temperature.

P-1: latex (molecular weight: 37,000) of -MMA(70)-EA(27)-MAA(3),

P-2: latex (molecular weight: 40,000) of -MMA(70)-2EHA(20)-St(5) -AA(5),

P-3: latex (crosslinking) of -St(50)-Bu(47)-MAA(3)-,

P-4: latex (crosslinking) of -St(68)-Bu(29)-AA(3)-,

P-5: latex (crosslinking, Tg: 24° C.) of -St(71)-Bu(26)-AA(3)-,

P-6: latex (crosslinking) of -St(70)-Bu(27)-IA(3)-,

P-7: latex (crosslinking) of -St(75)-Bu(24)-AA(1)-,

P-8: latex (crosslinking) of -St(60)-Bu(35)-DVB(3)-MAA(2)-,

P-9: latex (crosslinking) of -St(70)-Bu(25)-DBV(2)-AA(3)-,

P-10: latex (molecular weight: 80,000) of -VC(50)-MMA(20)-EA(20)-AN(5)-AA(5)-,

P-11: latex (molecular weight: 67,000) of -VDC(85)-MMA(5)-EA(5) -MAA(5) -,

P-12: latex (molecular weight: 12,000) of -Et(90)-MMA(10)-,

P-13: latex (molecular weight: 130,000) of -St(70)-2EHA(27)-AA(3)-,

P-14: latex (molecular weight: 33,000) of -MMA(63)-EA(35)-AA(2)-,

P-15: latex (crosslinking, Tg: 23° C.) of -St(70.5)-Bu(26.5)-AA(3)-, and

P-16: latex (crosslinking, Tg: 20.5° C.) of -St(69.5)-Bu(27.5)-AA(3)-.

The abbreviations above represent the following monomers. MMA: methyl methacrylate, EA: ethyl acrylate, MAA: methacrylic acid, 2EHA: 2-ethylhexyl acrylate, St: styrene, Bu: butadiene, AA: acrylic acid, DVB: divinylbenzene, VC: vinyl chloride, AN: acrylonitrile, VDC: vinylidene chloride, Et: ethylene, and IA: itaconic acid.

The above-mentioned polymer latexes are commercially available. Polymer as follows can be used. Examples of the acrylic polymer include Cebian A-4635, 4718 and 4601 (made by Daicel Chemical Industries, Ltd.), and Nipol Lx 811, 814, 821, 820 and 857 (made by Nippon Zeon Co., Ltd.). Examples of poly(esters) include FINETEX ES650, 611, 675 and 850 (made by Dainippon Ink & Chemicals, Inc.), and WD-size, and WMS (made by Eastman Chemical). Examples of the poly(urethanes) include HYDRAN AP 10, 20, 30 and 40 (made by Dainippon Ink & Chemicals, Inc.). Examples of the rubber include LACSTAR, 7310K, 3307B, 4700H, and 7132C (Dainippon Ink & Chemicals, Inc.), and Nipol Lx 416, 410, 438C, and 2507 (made by Nippon Zeon Co., Ltd.). Examples of the poly(vinyl chlorides) include G351, and G576 (made by Nippon Zeon Co., Ltd.). Examples of the poly(vinylidene chlorides) include L502, and L513 (made by Asahi Chemical Co., Ltd.). Examples of the poly(olefins) include Chemipearl S120 and SA100 (made by Mitsui Petrochemical Industries, Ltd.).

These polymer latexes may be used alone or may be, if necessary, used in combination of two or more kinds thereof.

As the polymer latex used in the invention, a latex of styrene-butadiene copolymer is particularly preferable. The weight ratio of the monomer unit of styrene to the monomer unit of butadiene in the styrene-butadiene copolymer is preferably from 40/60 to 95/5. The ratio of the styrene monomer unit and the butadiene monomer unit in the copolymer is preferably from 60 to 99% by mass. A preferable molecular weight thereof is the same as described above.

Preferable examples of the latex of the styrene-butadiene copolymer used in the invention include the above-mentioned P-3 to P-8, P14 and P15, and LACSTAR-3307B, 7132C, and Nipol Lx 416, which are commercially available.

If necessary, a hydrophilic polymer such as gelatin, polyvinyl alcohol, methylcellulose, hydroxypropylcellulose, or carboxymethylcellulose may be added to the organic silver salt-containing layer (photosensitive layer) of the heat-developable photosensitive material of the invention. The amount of the hydrophilic polymer to be added is preferably 30% or less, and more preferably 20% by mass or less of all of the binders in the organic silver salt-containing layer (photosensitive layer).

The layer containing the organic silver salt (photosensitive layer) in the invention is preferably formed using the polymer latex. About the amount of the binder in the organic silver salt-containing layer (photosensitive layer), the weight ratio of all the binders to the organic silver salt is preferably from 1/10 to 10/1 and more preferably from 1/5 to 4/1.

This organic silver salt-containing layer (photosensitive layer) is usually a photosensitive layer (emulsion layer) containing a silver halide, which is a photosensitive silver salt. In this case, the weight ratio of all the binders to the photosensitive silver halide is preferably from 400 to 5, more preferably from 200 to 10.

The amount of all the binders in the image forming layer in the invention is preferably from 0.2 to 30 g/m² and more preferably from 1 to 15 g/m². A crosslinking agent for crosslinking and a surfactant for improving coating property may be added to the image forming layer in the invention.

In the invention, the solvent of the coating liquid for the organic silver salt-containing layer is preferably an aqueous solvent containing 30% by mass or more of water (For simplicity, the word “solvent” means not only a solvent but also a dispersing medium.). Examples of a component other than water include all water-miscible organic solvents such as methyl alcohol, ethyl alcohol, isopropyl alcohol, methylcellusolve, ethylcellusolve, dimethylformamide, and ethyl acetate. The water content in the solvent of the coating liquid is preferably 50% by mass or more, and more preferably 70% by mass or more. Preferable examples of the composition of the solvent include water only, water/methyl alcohol=90/10, water/methyl alcohol=70/30, water/methyl alcohol/dimethylformamide=80/15/5, water/methyl alcohol/ethylcellusolve=85/10/5, and water/methyl alcohol/isopropyl alcohol=85/10/5 (the numbers being percentages by mass).

Examples of an antifoggant, a stabilizer, a stabilizer precursor which can be used in the invention include compounds described in JP-A No. 10-62899 (par. 0070), EP No. 0803764A1 (page 20, line 57 to page 21, line 7), JP-A Nos. 9-281637 and 9-329864. The antifoggant preferably used in the invention is an organic halide. Examples thereof include halides disclosed in JP-A No. 11-65021 (pars. 0111 to 0112). Particularly preferable are organic halides represented by the formula (P) in Japanese Patent Application No. 11-87297, organic polyhalides represented by the general formula (II) in JP-A No. 10-339934, and organic polyhalides described in Japanese Patent Application No. 11-205330. Additional preferable examples of the organic polyhalide which is used in the invention are compounds represented by the general formula (III) described in Japanese Patent Application No. 2000-358846. Specific examples thereof are described in the specification of this patent application.

In the invention, the compound represented by the general formula (III) described in Japanese Patent Application No. 2000-358846 is used preferably in an amount within the range of 10⁻⁴ to 1 mole, more preferably in an amount within the range of 10⁻³ to 0.8 mole, and most preferably in an amount within the range of 5×10⁻³ to 0.5 mole per mole of the non-photosensitive organic silver salt in the image forming layer.

Examples of the method of incorporating the antifoggant into the photosensitive material include the same methods for incorporating the reducing agent thereinto. It is preferable that the organic polyhalide compound is also added in the form of a solid fine grain dispersed product.

Other examples of the antifoggant include mercury (II) salts described in JP-A No. 11-65021 (par. 0113), benzoic acids in the same publication (par. 0114), salicylic acid derivatives in JP-A No. 2000-206642, formalin scavenger compounds represented by the formula (S) in the JP-A No. 2000-221634, triazine compounds in JP-A No. 11-352624 (claim 9), compounds represented by the general formula (III) in JP-A No. 6-11791, and 4-hydroxy-6-methyl-1,3,3a,7-tetraza indene.

The heat-developable photosensitive material of the invention may contain an azolium salt to prevent fogging. Examples of the azolium salt include compounds represented by the general formula (XI) described in JP-A No. 59-193447, compounds described in JP-B No. 55-12581, and compounds represented by the general formula (II) described in JP-A No. 60-153039. The azolium salt may be added to any portion of the photosensitive material. The azolium salt is preferably added to any layer in the aspect having the photosensitive layer, and is more preferably added to the organic silver salt-containing layer (photosensitive layer). The addition of the azolium salt may be performed in any step in the preparation of the coating liquid. In the case in which the azolium salt is added to the organic silver salt-containing layer, the addition may be performed in any step from the time of preparing the organic silver salt to the time of preparing the coating liquid, and is preferably performed after the preparation of the organic silver salt and immediately before the coating with the coating liquid. The addition of the azolium salt may be performed in any manner, for example, in the manner of powder, solution or fine grain dispersed product. The azolium salt may be added in the form of a solution wherein the salt is mixed with some other additive such as a sensitizing dye, a reducing agent, or a color tone adjuster. In the invention, the addition amount of the azolium salt added may be arbitrary. The amount is preferably from 1×10⁻⁶ to 2 moles, and more preferably from 1×10⁻³ to 0.5 mole per mole of silver.

In order to restrain or accelerate the development to control the development, improve spectrally sensitizing efficiency, or improve the storability before and after the development, a mercapto compound, a disulfide compound, a thione compound may be incorporated into the invention. These compounds are disclosed in JP-A No. 10-62899 (pars. 0067 to 0069), and JP-A No. 10-186572 (compounds represented by the general formula (I), and specific examples in pars. 0033 to 0052), EP No. 0803764A1 (page 20, lines 36 to 56), Japanese Patent Application No. 11-273670, and the like. Among these compounds, mercapto-substituted heteroaromatic compounds are preferable.

A color adjuster is preferably added to the heat-developable photosensitive material of the invention. The color adjuster is described in JP-A No. 10-62899 (pars. 0054 to 0055, EP No. 0803764A1 (page 21 lines 23 to 48), JP-A No. 2000-356317, and Japanese Patent Application No. 2000-187298. Particularly preferable are the following: phthalazinones (phthalazinone, phthalazinone derivatives or metal salts thereof, for example, 4-(1-naphthyl)phthalazinone); 6-chlorophthalazinone, 5,7-dimethoxyphthalazione, and 2,3-dihydro-1,4-phthalazinone); combinations of phthalazinones with phthalic acids(for example, phthalic acid, 4-methylphthalic acid, 4-nitrophthalic acid, diammonium phthalate, sodium phthalate, potassium phthalate, and tetrachloro phthalic anhidride); phthalazines (phthalazine, phthalazine derivatives or metal salts thereof, for example, 4-(1-naphthyl)phthalazine, 6-isopropylphthalazine, 6-t-butylphthalazine, 6-chlorophthalazine, 5,7-dimethoxyphthalazine, and 2,3-dihydrophthalazine); combinations of phthalazines with phthalic acids. Combinations of phthalazines with phthalic acids are more preferable.

A plasticizer and a lubricant which can be used in the invention are described in, for example, JP-A No. 11-65021 (par. 0117). A superhigh contrasting agent for forming a superhighly contrast image, a method of adding the same, and an amount thereof are described in, for example, JP-A No. 11-65021 (par. 0118), JP-A No. 11-223898 (pars. 0136 to 0193), Japanese Patent Application No. 11-87297 (compounds represented by the formulae (H), (1) to (3), (A) and (B)), Japanese Patent Application No. 11-91652 (compounds represented by the general formulae (III) to (V)) (specific examples of the compounds: compounds 21 to 24), and a superhigh contrast accelerator is described in, for example, JP-A No. 11-65021 (par. 0102), and JP-A No. 11-223898 (pars. 0194 to 0195).

In order to use formic acid, or a formic salt as a strong fogging agent, it is preferable that the heat-developable photosensitive material contains, in the aspect having the image forming layer containing a photosensitive silver halide, the acid or the salt in an amount of 5 mmoles or less, particularly 1 mmole or less per mole of silver.

In the case in which the superhigh contrast agent is used in the heat-developable photosensitive material of the invention, it is preferable to use an acid obtained by hydration of diphosphorous pentaoxide, or a salt thereof. Examples of the acid obtained by hydration of diphosphorous pentaoxide, or the salt thereof include metaphosphoric acid (salts thereof), pyrrophosphoric acid (and salts thereof), orthophosphoric acid (and salts thereof), triphosphoric acid (and salts thereof), tetraphosphoric acid (salts thereof), and hexametaphosphoric acid (and salts thereof). Preferable examples thereof are orthophosphoric acid (and salts thereof) and hexametaphosphoric acid (and salts thereof). Specific examples thereof include sodium orthophosphate, sodium dihydrogenphosphate, sodium hexametaphosphate, and ammonium hexametaphosphate.

The amount (coating amount per m² of the photosensitive material) of the acid obtained by hydration of diphosphorous pentaoxide, or the salt thereof used is a desired amount depending on performances such as sensitivity and fog, and is preferably from 0.1 to 500 mg/m², and more preferably from 0.5 to 100 mg/m².

Layer Structure

In order to prevent adhesion of the image forming layer to another material, a surface protective layer may be formed on the heat-developable photosensitive material of the invention. The surface protective layer may be made of a monolayer or a multilayer. The surface protective layer is described in, for example, JP-A No. 11-65021 (pars. 0119 to 0120), and Japanese Patent Application No. 2000-171936.

A binder of the surface protective layer in the invention is preferably gelatin, or polyvinyl alcohol (PVA), or a combination of gelatin with PVA. Examples of the gelatin include inert gelatin (for example, Nitta Gelatin 750), and phthalated gelatin (for example, Nitta Gelatin 801). Examples of PVA are described in JP-A No. 2000-171936 (pars. 0009 to 0020), and preferable examples thereof include PVA-105, which is a completely saponificated products, PVA-205 and PVA-335, which are partially saponificated products, and MP-203, which is modified PVA, These examples are all names of products made by Kurary Co., Ltd. The coating amount (per m² of the support) of polyvinyl alcohol in the protecting layer or in each of the protecting layers is preferably from 0.3 to 4.0 g/m², and more preferably from 0.3 to 2.0 g/m².

Particularly in the case in which the heat-developable photosensitive material of the invention is used for printing wherein a change in dimension comes into question, it is preferable to use a polymer latex in the surface protective layer or a back layer. This polymer latex is described in ed. Taira Okudaira and Hiroshi Inagaki, “Synthetic Resin Emulsions”, Koubunsi Kankou-kai 1978, ed. Takaaki Sugimura, Yasuo Kataoka, Soichi Suzuki, and Keizi Kasahara, “Application of Synthetic Latex”, Koubunshi Kankou-kai, 1993, and Soichi Muroi, “Chemistry on Synthetic Latex”, Koubunshi Kankou-kai, 1970, and the like. Specific examples thereof include a copolymer latex of methyl methacrylate (33.5% by mass)/ethyl acrylate (50% by mass)/methacrylic acid (16.5% by mass), a copolymer latex of methyl methacrylate (47.5% by mass)/butadiene(47.5% by mass)/itaconic acid (5% by mass), a copolymer latex of ethyl acrylate/methacrylic acid, a copolymer latex of methyl methacrylate (58.9% by mass)/2-ethylhexyl acrylate (25.4% by mass)/styrene (8.6% by mass)/2-hydroxyethyl methacrylate (5.1% by mass)/acrylic acid (2.0% by mass), and a copolymer latex of methyl acrylate (64.0% by mass)/styrene (9.0% by mass)/butyl acrylate (20.0% by mass)/2-hydroxyethyl methacrylate (5.0% by mass)/acrylic acid (2.0% by mass). For the binder for the surface protective layer, the following techniques may be used: a combination of polymer latexes described in Japanese Patent Application 11-6872, a technique described in Japanese Patent Application 11-143058 (pars. 0021 to 0025), a technique described in Japanese Patent Application 11-6872 (pars. 0027 to 0028), or a technique described in Japanese Patent Application 10-199626 (pars. 0023 to 0041). The ratio of the polymer latex in the surface protective layer is preferably from 10 to 90%, and more preferably from 20 to 80% by mass of all the binders.

The coating amount (per m² of the support) of all the binders (containing the water-soluble polymer and the latex polymer) in the surface protective layer or in each of the surface protective layers is preferably from 0.3 to 5.0 g/m², and more preferably from 0.3 to 2.0 g/m².

The preparation temperature of the image forming layer coating liquid in the invention is preferably from 30 to 65° C., more preferably from 35 to 60° C., and most preferably from 35 to 55° C. It is preferable that the temperature of the image forming layer coating liquid immediately after the addition of the polymer latex is kept at 30 to 65° C.

The image forming layer in the invention is made of one or more layers over the support. In the case in which the image forming layer is made of a single layer, the layer is composed of an organic silver salt, a photosensitive silver halide, a reducing agent and a binder. If necessary, the layer contains desired additional materials such as a color adjuster, a coating auxiliary agent and some other auxiliary agent. In the case in which the image forming layer is made of two or more layers, it is essential that the first image forming layer, which is usually adjacent to the support, contains an organic silver salt and a photosensitive silver halide. The second image forming layer or both the layers must contain some of the other components. In the structure of a multicolor heat-developable photosensitive photographic material, the combination of these two layers may be used for each of the colors. All the components may be contained in a single layer as described in U.S. Pat. No. 4,708,928. In the case of a multi-dye, multicolor, photosensitive heat-developable photographic material, respective layers thereof are generally distinguished from each other by using a functional or non-functional barrier layer between the respective layers, as described in U.S. Pat. No. 4,460,681.

In order to improve the color tone, prevent the generation of interference fringes at the time of later exposure, and prevent irradiation, various dyes or pigments (For example, C. I. Pigment Blue 60, C.I. Pigment Blue 64, and C. I. Pigment Blue 15:6) may be used in the photosensitive layer in the invention. These are described in WO 98/36322, JP-A Nos. 10-268465, 11-338098, and the like.

In the heat-developable photosensitive of the invention, an antihalation layer may be formed at the side farther, across the photosensitive layer, from a light source.

A heat-developable photosensitive material in general has not only a photosensitive layer but also a non-photosensitive layer. The non-photosensitive layer can be classified into the following from the viewpoint of the arrangement thereof: (1) a protective layer formed on/over the surface (farther from the support) of the photosensitive layer, (2) an intermediate layer between the photosensitive layers, or between the photosensitive layer and the protective layer, (3) an undercoat layer formed between the photosensitive layer and the support, and (4) a back layer on the side opposite to the photosensitive layer. A filter layer is fitted as the layer (1) or layer (2) to the photosensitive material, and the antihalation layer is fitted as the layer (3) or (4) to the photosensitive material.

The antihalation layer is described in JP-A Nos. 11-65021 (pars. 0123 to 124), 11-223898, 9-230531, 10-36695, 10-104779, 11-231457, 11-352625, 11-352626.

The antihalation layer contains an antihalation dye having an absorption wavelength within the range of wavelengths for exposure. In the case in which the exposure wavelengths are within the range of infrared rays, an infrared ray absorbing dye should be used. In this case, a dye having no absorption wavelength within the range of visible rays is preferable.

In the case in which the dye having an absorption wavelength within the range of visible rays is used to prevent halation, it is preferable that the color of the dye does not substantially remain after an image is formed. It is preferable to use a means for erasing the color by heat based on heat development. It is particularly preferable to add a heat color-erasing dye and a basic precursor to the non-photosensitive layer so as to be caused to function as the antihalation. These techniques are described in JP-A No. 11-231457.

The addition amount of the color-erasing dye is decided dependently on the use of the dye. In general, the dye is used at such a level that causes the optical density (absorbancy) of the dye, which is measured with a target wavelength, to be over 0.1. The optical density is preferably from 0.2 to 2. The use amount of the dye for obtaining such an optical density is generally from about 0.001 to 1 g/m².

When the color of the dye is erased in such a manner, the optical density after heat development can be lowered to 0.1 or less. Two or more kinds of the color-erasing dye may be used together in a heat-erasable recording material or the heat-developable photosensitive material. Similarly, two or more kinds of the basic precursor may be used together.

In the heat-erasion using the color-erasing dye and the basic precursor in this way, it is preferable from the viewpoint of heat-erasability and the like to use a material that cause the melting point to be lowered to a degree of 3° C. or more when mixed with the basic precursor (for example, diphenylsulfone, or 4-chlorophenyl(phenyl)sulfone), as described in JP-A No. 11-352626.

In order to improve a silver color tone, and performance against a change of images over time, a colorant having a maximum absorption wavelength of 300 to 450 nm may be added to the photosensitive material of the invention. This colorant is described in JP-A Nos. 62-210458, 63-104046, 63-103235, 63-208846, 63-306436, 63-314535, 01-61745, Japanese Patent Application No. 11-276751, and the like.

This colorant is added generally in an amount of 0.1 to 1 g/m². The layer to which the colorant is added is preferably the back layer formed on the side opposite to the photosensitive layer across the support.

The heat-developable photosensitive material of the invention is preferably the so-called one-side photosensitive material, which has at least one photosensitive layer containing the silver halide emulsion on one side of the support and has a back layer on the opposite side.

In order to improve the carriage property of the photosensitive material of the invention, it is preferable to add a matting agent thereto. The matting agent is described in, for example, JP-A No. 11-65021 (pars. 0126 to 0127). The coating amount of the matting agent is preferably from 1 to 400 mg, and more preferably from 5 to 300 mg per m² of the photosensitive material.

The mat degree of the emulsion surface is not limited as long as no stardust defect is generated. The Beck smoothness of the emulsion surface is preferably from 30 to 2,000 seconds, more preferably from 40 to 1,500 seconds. The Beck smoothness can easily be obtained according to “Smoothness Testing Method of Paper and Paperboard Using Beck Tester” in JIS (Japanese Industrial Standard) P 8119, and TAPPI Standard Method T479.

The Beck smoothness of the mat degree of the back layer in the invention is preferably from 10 to 1,200 seconds, more preferably from 20 to 800 seconds, and most preferably from 40 to 500 seconds.

In the invention, it is preferable that the matting agent is contained in the outermost layer of the photosensitive material, a layer functioning as the outermost layer, or a layer near the outer surface, and it is preferable that the matting agent is contained in a layer acting as the so-called protective layer.

The back layer which can be used in the invention is described in JP-A No. 11-65021 (pars. 0128 to 0130).

In the heat-developable photosensitive material of the invention, the film face pH before heat development is preferably 7.0 or less and more preferably 6.6 or less. The lower limit thereof is not particularly limited, but is about 3. The most preferable range of the pH is from 4 to 6.2. In order to reduce the film face pH, it is preferable to use an organic acid such as a phthalic acid derivative, a nonvolatile acid such as sulfuric acid, or a volatile base such as ammonia. Ammonia is particularly preferable for attaining a low film face pH since it volatilizes easily and it can be removed in the step of coating or before heat development.

It is also preferable to use a nonvolatile base such as sodium hydroxide, potassium hydroxide or lithium hydroxide together with ammonia. A method of measuring the film face pH is described in par. 0123 of Japanese Patent Application No. 11-87297.

A hardening agent may be used in the respective layers in the invention, for example, the photosensitive layer, the protecting layer and the back layer. Examples of the hardening agent are described on pages 77 to 87 of T. H. James, “THE THEORY OF THE PHOTOGRAPHIC PROCESS FOURTH EDITION”, Macmillan Publishing Co., Inc., 1977. For example, the following are preferably used: chromium alum, a sodium salt of 2,4-dichloro-6-hydroxy-s-triazine, N,N-ethylenebis(vinylsulfoneacetoamide), N,N-propylenebis(vinylsulfoneacetoamide), polyvalent metal ions described on page 78 of the same document and the like, polyisocyanates described in U.S. Pat. No. 4,281,060, JP-A No. 6-208193 and the like, epoxy compounds described in U.S. Pat. No. 4,791,042 and the like, vinylsulfone compounds described in JP-A No. 62-89048 and the like.

The hardening agent is added in the form of a solution thereof, and the time to add this solution to the protective layer coating liquid is from 180 minutes before coating thereof to a time immediately before the coating, and preferably from 60 minutes before the coating to 10 seconds before the coating. The method of mixing the hardening agent solution with the coating liquid, and conditions for the mixing are not particularly limited if the effect of the invention is sufficiently produced. Specific examples of the mixing method include a method of mixing them in a tank, and storing the mixture for an average remaining time, which time is calculated from an addition flow rate and an amount of a solution sent to a coater and set to a desired time, and a method of using a static mixer, described in N. Harnby, M. F. Edwards and A. W. Nienow, trans. Koji Takahashi, “Liquid Mixing Technique”, The Nikkann Kogyo Shimbun, Ltd., 1989, Chapter 8.

The surfactant which can be used in the invention is described in par. 0132 of JP-A No. 11-65021; the solvent, in par. 0133 of the same publication; the support, in par. 0134 of the same publication; the antistatic layer or a conductive layer, in par. 0135 of the same publication; the method of obtaining color images, in par. 0136 of the same publication; and the lubricant, in pars. 0061 to 0064 of JP-A No. 11-84573 and in pars. 0049 to 006 of Japanese Patent Application No. 11-106881.

Support

As the support which is used in the invention, a transparent support, such as a polyester film, subjected to heat treatment within the temperature range of 130 to 185° C. to relieve inner strain remaining in the film from the time of biaxial drawing and remove thermal contraction strain generated in heat development, particularly a polyethylene terephthalate film is preferably used. In the case of a heat-developable photosensitive material for medicine, the transparent support may be colored with a blue dye (for example, dye-1 described in Examples in JP-A No. 8-240877), or may not be colored. The following techniques are preferably applied to the support: undercoating techniques of water-soluble polyester in JP-A No. 11-84574, styrene-butadiene copolymer in JP-A No. 10-186565, and vinylidene chloride in JP-A No. 2000-39684 and Japanese Patent Application No. 11-106881 (pars. 0063 to 0080). For the antistatic layer or the undercoat layer, the following techniques can be used: JP-A Nos. 56-143430, 56-143431, 58-62646, 56-120519, 11-84573 (pars. 0040 to 0051), U.S. Pat. No. 5,575,957, and JP-A No. 11-223898 (pars. 0078 to 0084).

The heat-developable photosensitive material is preferably of a mono-sheet type (i.e., of a type makable to form images on the heat-developable photosensitive material without using any other sheet, such as an image receiving material).

An antioxidant, a stabilizer, a plasticizer, an ultraviolet absorber, or a coating auxiliary may be added to the heat-developable photosensitive material. Various additives are added to either of the photosensitive layer and the non-photosensitive layer. These additives are described in WO 98/36322, EP No. 803764A1, JP-A Nos. 10-186567, 10-18568.

Production of the Heat-Developable Photosensitive Material

In the heat-developable photosensitive material of the invention, its photosensitive layer is formed by applying a coating liquid for the photosensitive layer containing silver behenate and drying the liquid through the above-mentioned first step.

The heat-developable photosensitive material of the invention may be applied in any manner. Specifically, various coating operations such as extrusion coating, slide coating, curtain coating, dipping coating, knife coating, flow coating, or extrusion coating using a hopper of a type described in U.S. Pat. No. 2,681,294 are used. An extrusion coating described in Kistler, Stephen F. and Petert M. Schweizer, “LIQUID FILM COATING”, CHAPMAN & HALL Co., 1997, pp.399 to 536, or slide coating are used. Particularly preferable is slide coating.

An example of the shape of a slide coater used in slide coating is described in FIG. 11b.1 on page 427 of the same document. If desired, two or more layers can be applied at the same time by a method described in any of the same document (pages 399 to 536), U.S. Pat. No. 2,761,791, and British Patent No. 837,095.

The coating liquid containing the organic silver salt (coating liquid for a photosensitive layer) in the invention is preferably so-called thixotropic fluid. This technique is described in JP-A No. 11-52509. About the organic silver salt-containing coating liquid of the invention, the viscosity thereof at a shear speed of 0.1 S⁻¹ is from 400 to 100,000 mPa·s and more preferably from 500 to 20,000 mPa·s. The viscosity at a shear speed of 1000 S⁻¹ is preferably from 1 to 200 mPa·s and more preferably from 5 to 80 mPa·s.

Other examples of the technique which can be used for the heat-developable photosensitive material of the invention are described in EP No. 803764A1, EP No. 883022A1, WO 98/36322, JP-A Nos. 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-18569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099 and 11-343420, and Japanese Patent Application Nos. 2000-187298, 2000-10229, 2000-47345, 2000-206642, 2000-98530, 2000-98531, 2000-112059, 2000-112060, 2000-112104, 2000-112064, and 2000-171936.

Exposure and Heat Development

The heat-developable photosensitive material of the invention may be developed by any method. Usually, the heat-developable photosensitive material which has been imagewise exposed to light is heated to be developed. Development temperature is preferably from 80 to 250° C. and more preferably from 100 to 140° C. Development time is preferably from 1 to 60 seconds, more preferably from 5 to 30 seconds, and most preferably from 10 to 20 seconds.

The system of the heat development is preferably a plate heater system. A preferable example of the heat development according to the plate heater system is described in JP-A No. 11-133572. A heat development device used in this system is a heat development device capable of obtaining a visible image by bringing a heat-developable photosensitive material having a latent image formed thereon into contact with a heating system in a heat-developing section, wherein the heating system comprises a plate heater, pressing rolls are arranged opposite to each other along one face of the plate heater, and the heat-developable photosensitive material is caused to pass between the pressing rolls and the plate heater to perform heat development. It is preferable to separate the plate heater into 2 to 6 units and further lower the temperature of the tip portion thereof by about 1 to 10° C. This method is also described in JP-A No. 54-30032. Water content and organic solvents contained in the heat-developable photosensitive material can be removed outside the system. It is also possible to suppress a change in the shape of the support of the heat-developable photosensitive material, the change being based on drastic heating of the photosensitive material.

The heat-developable photosensitive material of the invention may be exposed to light by any method. An exposure source for the exposure is preferably a laser ray. Preferable examples of the laser ray in the invention include a gas laser (Ar⁺, or He—Ne), a YAG laser, a dye laser, and a semiconductor laser. Moreover, a semiconductor laser and a second harmonic generating element can also be used. A gas or semiconductor laser that emits rays from red rays to infrared rays is preferable.

An example of a laser imager for medicine having an exposure section and a heat development section is a Fuji Medical Dry Laser Imager FM-DP L. The FM-DP L is described on pages 39 to 55 of Fuji Medical Review No. 8. Techniques therein can be used as the laser imager for the heat-developable photosensitive material of the invention. The heat-developable photosensitive material of the invention can be used as the heat-developable photosensitive material for the laser imager in an “AD network”, which is proposed as a network adapted to the DICOM Standard by Fuji Medical System.

The heat-developable photosensitive material of the invention can make black and white images based on silver images, and is preferably used as the heat-developable photosensitive material for medical diagnosis, the heat-developable photosensitive material for industrial photography, the heat-developable photosensitive for printing, or the heat-developable photosensitive material for COM.

### EXAMPLES

The present invention will be specifically described by way of Examples hereinafter, but the invention is not limited thereto.

Production of PET Support

Terephthalic acid and ethylene glycol were used to yield PET having an intrinsic viscosity IV (measured at 25° C. in phenol and tetrachloroethane (mass ratio=6/4)) of 0.66 by a conventional method. This was made into a pellet form, and then the pellet was dried at 130° C. for 4 hours and melted at 300° C. Thereafter, the melted PET was extruded from a T-shaped die and cooled rapidly. In this way, a film which has not yet been drawn was produced in such a manner that the film thickness thereof after heat fixation would be 175 μm.

Rolls having different peripheral speeds were used to draw this film 3.3 times lengthwise, and a tenter was used to draw the film 4.5 times sideways. The temperatures at these times were 110° C. and 130° C., respectively. Thereafter, the film was subjected to heat fixation at 240° C. for 20 seconds, and then relieved by 4% sideways at the same temperature. Thereafter, a chuck unit of the tenter was slit and subsequently both ends thereof were subjected to knurl working. The film was wound at 4 kg/cm², and made into the form of a roll having a thickness of 175 μm.

Surface Corona Treatment

A solid state corona treatment machine (6KVA model), made by Pillar Co. was used to treat both faces of the support at room temperature and a speed of 20 m/minute. It was discovered from current and voltage values read at this time that the support was treated at 0.375 kV·A·minutes/m². At this time, the frequency for the treatment was 9.6 kHz, and the gap clearance between the electrode and the dielectric roll was 1.6 mm.

Production of an Undercoated Support

<Production of a Coating Liquid for an Undercoat Layer>

Formulation (1) (for undercoat layer on photosensitive layer side)

| | | |
|---|---|---|
| Pesresin A-515GB made by Takamatsu Yushi Co., Ltd. | 234 | g |
| (30 mass % solution) | | |
| polyethylene glycol monononyl phenyl ether | 21.5 | g |
| (10 mass % solution) | | |
| (average ethylene oxide number = 8.5) | | |
| MP-1000 (polymer fine grains, average grain size: 0.4 μm) | 0.91 | g |
| made by Soken Chemical & Engineering Co., Ltd. | | |
| distilled water | 744 | ml |

Formulation (2) (for first layer on back face side)

| | | |
|---|---|---|
| styrene-butadiene copolymer latex | 158 | g |
| (solid content: 40 mass %, styrene/butadiene | | |
| (weight ratio) = 68/32) | | |
| sodium salt of 2,4-dichloro-6-hydroxy-S-triazine | 20 | g |
| (8 mass % aqueous solution) | | |
| sodium laurylbenzenesulfonate | 10 | ml |
| (1 mass % aqueous solution) | | |
| distilled water | 854 | ml |

Formulation (3) (for second layer on back face side)

| | | |
|---|---|---|
| SnO₂/SbO (mass ratio: 9/1, average grain size: 0.038 μm, | 84 | g |
| 17 mass % dispersed product) | | |
| gelatin (10 mass % aqueous solution) | 89.2 | g |
| Metorose TC-5 (2 mass % aqueous solution) | 8.6 | g |
| made by Shin-Etsu Chemical Co., Ltd. | | |
| MP-1000 made by Soken Chemical Co., Ltd. | 0.01 | g |
| sodium dodecylbenzenesulfonate | 10 | ml |
| (1 mass % aqueous solution) | | |
| NaOH (1 mass %) | 6 | ml |
| Proxel (made by ICI Co.) | 1 | ml |
| distilled water | 805 | ml |

Production of Undercoated Support

Each of two faces of the above-mentioned biaxially drawn polyethylene terephthalate support which has a thickness of 175 μm was subjected to corona discharge treatment and subsequently the undercoat layer coating liquid formulation (1) was applied to one face (photosensitive layer face) thereof in atmospheres having each different cleanlinesses (a) to (1) shown in Table 1 with a wire bar in such a manner that the wet coating amount would be 6.6 ml/m² (per face). The support was then dried at 180° C. for 5 minutes. Next, the undercoat layer coating liquid formulation (2) was applied to the back face with a wire bar in such a manner that the wet coating amount would be 5.7 ml/m² (per face). The support was then dried at 180° C. for 5 minutes. Furthermore, the undercoat layer coating liquid formulation (3) was applied to the back face with a wire bar in such a manner that the wet coating amount would be 7.7 ml/m² (per face). The support was then dried at 180° C. for 6 minutes. Thus, undercoated supports A to L were produced.

TABLE 1

| | Cleanliness Class | Cleanliness Class | |
|---|---|---|---|
| | (based on meters) | based on feet | Remarks |
| (a) | M4.80 | 1800 | The invention |
| (b) | M5.24 | 4900 | The invention |
| (c) | M5.45 | 8000 | The invention |
| (d) | M5.72 | 15000 | Comparative Example |
| (e) | M4.72 | 1500 | The invention |
| (f) | M5.13 | 3800 | The invention |
| (g) | M5.26 | 5200 | The invention |
| (h) | M5.53 | 9700 | Comparative Example |
| (i) | M4.63 | 1200 | The invention |
| (j) | M5.08 | 3400 | The invention |
| (k) | M5.29 | 5500 | The invention |
| (l) | M5.56 | 10200 | Comparative Example |

Preparation of Back Face Coating Liquid

<Preparation of Solid Fine Grain Dispersed Liquid (a) of Basic Precursor>

64 g of a basic precursor 11, 28 g of diphenylsulfone, and 10 g of a surfactant Demol N made by Kao Corp. were mixed with 220 ml of distilled water. The mixed solution was subjected to bead-dispersion using a sand mill (¼ Gallon Sand Grinder Mill, made by Aimex Co., Ltd.) to yield a solid fine grain dispersed liquid (a) of the basic precursor compound having an average grain size of 0.2 μm.

<Preparation of Dye Solid Fine Grain Dispersed Liquid>

9.6 g of a cyanine dye compound 13, and 5.8 g of sodium p-dodecylbenzenesulfonate were mixed with 305 ml of distilled water. The mixed solution was subjected to bead-dispersion using a sand mill (¼ Gallon Sand Grinder Mill, made by Aimex Co., Ltd.) to yield a dye solid fine grain dispersed liquid having an average grain size of 0.2 μm.

<Preparation of Antihalation Layer Coating Liquid>

The following were mixed: 17 g of gelatin, 9.6 g of polyacrylamide, 70 g of the solid fine grain dispersed liquid (a) of the basic precursor, 56 g of the dye solid fine grain dispersed liquid, 1.5 g of mono-dispersed fine grains of polymethyl methacrylate (average grain size: 8 μm, grain size standard deviation: 0.4), 0.03 g of benzoisothiazolinone, 2.2 g of sodium polyethylene sulfonate, 0.2 g of a blue dye compound 14, 3.9 g of a yellow dye compound 15, and 844 ml of water. In this way, an antihalation layer coating liquid was prepared.

<Preparation of Back Face Protective Layer Coating Liquid>

The temperature of a container was kept at 40° C., and the following were mixed: 50 g of gelatin, 0.2 g of sodium polystyrene sulfonate, 2.4 g of N,N-ethylenebis(vinylsulfoneacetoamide), 1 g of sodium t-octylphenoxyethoxyethane sulfonate, 30 mg of benzoisothiazolinone, 37 mg of a fluorinated surfactant (F-1: a potassium salt of N-perfluorooctylsulfonyl-N-propylalanine, a fluorinated surfactant (F-2: polyethylene glycol mono(N-perfluorooctylsulfonyl-N-propyl-2-aminoethyl)ether [ethylene oxide average polymerization degree: 15], 64 mg of a fluorinated surfactant (F-3), 32 mg of a fluorinated surfactant (F-4), 8.8 g of acrylic acid/ethyl acrylate copolymer (copolymerization weight ratio: 5/95), 0.6 g of an aerosol OT (made by American Sianamide Co.), 1.8 g (as a fluid paraffin) of a fluid paraffin emulsion, and 950 ml of water. In this way, a back face protective layer coating liquid was prepared.

<<Preparation of Silver Halide Emulsion-1>>

To 1421 ml of distilled water was added 3.1 ml of 1 mass % potassium bromide solution, and to this mixture were added 3.5 ml of 0.5 mol/L sulfuric acid, and 31.7 g of phthalated gelatin. While this solution was stirred in a reaction vessel made of stainless steel, the temperature of the solution was kept at 30° C. Thereto the entire amounts of the following were added at a constant flow rate over 45 seconds, a solution A wherein distilled water was added to 22.22 g of silver nitrate so as to increase the volume to 95.4 ml and a solution B wherein distilled water was added to 15.3 g of potassium bromide and 0.8 g of potassium iodide so as to increase the volume to 97.4 ml. Thereafter, thereto were added 10 ml of 3.5 mass % aqueous hydrogen peroxide solution and further 10.8 ml of 10 mass % aqueous benzimidazole solution. Furthermore, thereto were added a solution C wherein distilled water was added to 51.86 g of silver nitrate to increase the volume to 317.5 ml, and a solution D wherein distilled water was added to 44.2 g of potassium bromide and 2.2 g of potassium iodide so as to increase the volume to 400 ml. The entire amount of the solution C was added at a constant flow rate over 20 minutes, and the solution D was added by a controlled double jet method while the pAg thereof was kept at 8.1. The entire amount of a potassium salt of iridium hexachloride (III) acid was added to the solution after 10 minutes from the start of the addition of the solutions C and D in such a manner that the amount of the potassium salt would be 1×10⁻⁴ mole per mole of silver. After 5 seconds after the end of the addition of the solution C, the entire amount of an aqueous hexacyano ferrate (II) potassium solution was added to the above-mentioned solution in a rate of 3×10⁻⁴ mole per mole of silver. Sulfuric acid having a concentration of 0.5 mole/L was used to adjust the pH of the solution to 3.8, and then stirring was stopped. Then, precipitating, desalting, and water washing steps were performed. Sodium hydroxide having a concentration of 1 mole/L was used to adjust the pH to 5.9. In this way, a silver halide dispersed product having a pAg of 8.0 was prepared.

While the silver halide dispersed product was stirred, the temperature thereof was kept at 38° C. Thereto was added 5 ml of a 0.34% mass solution of 1,2-benzoisothiazoline-3-one in methanol. After 40 minutes, thereto a solution of a spectrally sensitizing dye A and a spectrally sensitizing dye B (molar ratio=1:1) in methanol was added in such a manner that the total amount of the dyes A and B would be 1.2×10⁻³ mole per mole of silver. After one minute, the temperature of the solution was raised to 47° C. After 20 minutes from the rise in the temperature, to the solution was added a solution of sodium benzenethiosulfonate in methanol in an amount of 7.6×10⁻⁵ mole per mole of silver. After 5 minutes, to the solution was added a solution of a tellurium sensitizing agent C in methanol in an amount of 2.9×10⁻⁴ mole per mole of silver. The resultant solution was ripened for 91 minutes. Thereto 1.3 ml of a 0.8 mass % solution of N,N′-dihydroxy-N″-diethylmelamine in methanol, and after 4 minutes thereto a solution of 5-methyl-2-mercaptobenzimidazole in methanol in an amount of 4.8×10⁻³ mole per mole of silver and a solution of 1-phenyl-2-heptyl-5-mercapto-1,3,4-triazole in an amount of 5.4×10^{31 3} mole per mole of silver were added. In this way, a silver halide emulsion-1 was prepared.

Grains of the prepared silver halide emulsion were silver iodobromide uniformly containing 3.5% by mole of iodine whose average sphere equivalent diameter was 0.042 μm and whose variation coefficient of the sphere equivalent diameter was 20%. The grain size and the like were calculated as an average value of 1000 grains, using an electron microscope. The {100} plane ratio of the grains was 80% according to Kubelka-Munk process.

<<Preparation of Silver Halide Emulsion-2>>

A silver halide emulsion-2 was prepared in the same way as in the preparation of the silver halide emulsion-1 except that the solution temperature at the time of the formation of the grains was changed from 30° C. to 47° C., the solution B was changed to a solution wherein distilled water was added to 15.9 g of potassium bromide so as to increase the volume to 97.4 ml, the solution D was changed to a solution wherein distilled water was added to 45.8 g of potassium bromide so as to increase the volume to 400 ml, the time of adding the solution C was changed to 30 minutes, and tetracyano ferrate (II) potassium was removed. In the same way as in the case of the silver halide emulsion-1, precipitation, desalting, water washing and dispersion were performed. In the same way as in the case of the silver halide emulsion-1, spectral sensitization, chemical sensitization and the addition of 5-methyl-2-mercaptobenzimidazole and 1-phenyl-2-heptyl-5-mercapto-1,3,4-triazole were performed except that the addition amount of the solution of the spectrally sensitizing dye A and the spectrally sensitizing dye B (molar ratio=1:1) in methanol was changed to 7.5×10⁻⁴ mole as a total amount of the two dyes A and B per mole of silver, the addition amount of the tellurium sensitizer C was changed to 1.1×10⁻⁴ mole per mole of silver, and the amount of 1-phenyl-2-heptyl-5-mercapto-1,3,4-triazole was changed to 3.3×10⁻³ per mole of silver. In this way, a silver halide emulsion-2 was prepared. The emulsion grains of the silver halide emulsion-2 were pure silver bromide cubic grains whose average sphere equivalent diameter was 0.080 μm and whose variation coefficient of the sphere equivalent diameter was 20%.

<<Preparation of Silver Halide Emulsion-3>>

A silver halide emulsion-3 was prepared in the same way as in the preparation of the silver halide emulsion-1 except that the solution temperature at the time of the formation of the grains was changed from 30° C. to 27° C. In the same way as in the case of the silver halide emulsion-1, precipitation, desalting, water washing and dispersion were performed. In the same way as in the case of the silver halide emulsion-1, the silver halide emulsion-3 was obtained except that the addition amount of the solid dispersed product (aqueous gelatin solution) of the spectrally sensitizing dye A and the spectrally sensitizing dye B (molar ratio=1:1) was changed to 6×10⁻³ mole as a total amount of the two dyes A and B per mole of silver and the addition amount of the tellurium sensitizer C was changed to 5.2×10⁻⁴ mole per mole of silver. The emulsion grains of the silver halide emulsion-3 were silver iodobromide grains uniformly containing 3.5% by mole of iodine whose average sphere equivalent diameter was 0.034 μm and whose variation coefficient of the sphere equivalent diameter was 20%.

<<Preparation of Silver Halide Mixture Emulsion A for Coating Liquid>>

The silver halide emulsion-1, the silver halide emulsion-2 and the silver halide emulsion-3 were dissolved in water that the amounts thereof would be 70 mass %, 15 mass % and 15 mass %, respectively. Thereto was added a 1 mass % solution of benzothiazolium iodide in water in an amount of 7×10⁻³ mole per mole of silver. Furthermore, water was added thereto in such a manner that the content of the silver halide would be 38.2 g as silver per kg of the silver halide mixture emulsion for a coating liquid.

<<Preparation of Organic Silver Salt Dispersed Product>>

The following were mixed: 87.6 g of behenic acid (trade name: Edenor C22-85R) made by Henckel Co., 423 L of distilled water, 49.2 L of an 5 mol/L aqueous NaOH solution, and 120 L of tert-butanol. The mixture was stirred at 75° C. for 1 hour to advance reaction. In this way, a sodium behenate solution was yielded. Separately, 206.2 L (pH: 4.0) of an aqueous solution of 40.4 kg silver nitrate was prepared, and the temperature of the solution was kept at 10° C. A reaction container in which 635 L of distilled water and 30 L of tert-butanol were put was kept at 30° C. While the solution was sufficiently stirred, thereto were added the entire amount of the sodium behenate solution and all amount of the aqueous silver nitrate solution at constant flow rates over 93 minutes 15 seconds and 90 minutes, respectively. In this case, for 11 minutes after the start of the addition of the aqueous silver nitrate solution, only the aqueous silver nitrate solution was added. Thereafter, the addition of the sodium behenate solution was started. For 14 minutes 15 seconds after the end of the addition of the aqueous silver nitrate solution, only the sodium behenate solution was added. At this time, the temperature of the reaction container was set to 30° C., and external temperature control was performed to make the temperature of the solution constant. Laying pipes of the sodium behenate adding system were kept warm by circulating hot water to the outside of its double pipes thereof, and the solution temperature of an outlet made at the tip of an adding nozzle was adjusted to 75° C. Pipes of the adding system of the aqueous silver nitrate were kept cool by circulating cool water to the outside of its double pipes. Positions where the sodium behenate solution and the aqueous silver nitrate solution were added were set to be symmetrical around a stirring axis as a center. The positions were also adjusted not to contact the reaction solution.

After the end of the addition of the sodium behenate solution, the reaction system was stirred for 20 minutes while being kept at the temperature thereof. Then the temperature of the system was raised to 35° C. over 30 minutes. Thereafter, the reaction system was ripened for 210 minutes. Immediately after the end of the ripening, a solid was collected by centrifugal filtration, and then the solid was washed with water until the electroconductivity of filtrated water was 30 μS/cm. In this way, an organic silver salt was yielded. The resultant solid was stored as a wet cake without being dried.

The form of the resultant silver behenate grains was observed with an electron microscope. As a result, the grains were in the form of a scale-shaped crystal having a of 0.14 μm, b of 0.4 μm, c of 0.6 μm, an average aspect ratio of 5.2, an average sphere equivalent diameter of 0.52 μm, and a variation coefficient of the sphere equivalent diameter of 15% (a, b and c were defined above).

To the wet case corresponding to a dry solid content of 260 kg were added 19.3 kg of polyvinyl alcohol (trade name: PVA-217), and water to increase the total volume to 1000 kg. The resultant was turned to a slurry by means of dissolver fins, and further the slurry was pre-dispersed with a pipe line mixer (PM-10 type, made by Mizuho Kougyou Co.).

Next, the pre-dispersed stock solution was subjected to dispersion treatment 3 times with a dispersing machine (trade name: Microfluidizer M-610, using a Z type interaction chamber made by Microfluidex International Corp.) at a pressure adjusted to 1260 kg/cm² (12.6 MPa). In this way, a silver behenate dispersed product was yielded. A cooling operation was performed by mounting a flexible tube type heat exchanger was set to each of the front and rear of the interaction chamber, and then setting a dispersion temperature to 10° C. by adjusting the temperature of a coolant.

<<Preparation of Reducing Agent-1 Dispersed Product>>

To 10 kg of a reducing agent-1 (1,1-bis(2-hydroxy-3,5-dimethylphenyl)-3,5,5-trimethylhexane) and 10 kg of a 20 mass % aqueous solution of a modified polyvinyl alcohol (Poval MP203, made by Kuraray Co., Ltd.) was added 16 kg of water, and the resultant was sufficiently stirred to prepare a slurry. This slurry was sent to a lateral type sand mill (UVM-2, made by Aimex CO., Ltd.), filled with zirconia beads having an average diameter of 0.5 mm, by means of a diaphragm pump, and dispersed therein for 3 hours 30 minutes. Thereafter, 0.2 g of a sodium salt of benzoisothiazolinone and water were added to the slurry, to set the concentration of the reducing agent to 25 mass %. In this way, a reducing agent-1 dispersed product was prepared. Reducing agent grains contained in the thus obtained reducing agent-1 dispersed product had a median size of 0.42 μm and a maximum grain size of 2.0 μm or less. The resultant reducing agent-1 dispersed product was filtrated with a filter made of polypropylene and having a pore diameter of 10.0 μm, to remove alien substance such as dusts, and was stored.

<<Preparation of Reducing Agent-2 Dispersed Product>>

To 10 kg of a reducing agent-2 (2,2′-isobutylidene-bis-(4,6-dimethylphenol)) and 10 kg of a 20 mass % aqueous solution of a modified polyvinyl alcohol (Poval MP203, made by Kuraray Co., Ltd.) was added 16 kg of water, and the resultant was sufficiently mixed to prepare a slurry. This slurry was sent to a lateral type sand mill (UVM-2, made by Aimex Co., Ltd.), filled with zirconia beads having an average diameter of 0.5 mm, by means of a diaphragm pump, and dispersed therein for 3 hours 30 minutes. Thereafter, 0.2 g of a sodium salt of benzoisothiazolinone and water were added to the slurry, to make the concentration of the reducing agent 25 mass %. In this way, a reducing agent-2 dispersed product was prepared. Reducing agent grains contained in the thus obtained reducing agent-2 dispersed product had a median size of 0.38 μm and a maximum grain size of 2.0 μm or less. The resultant reducing agent-2 dispersed product was filtrated with a filter made of polypropylene and having a pore diameter of 10.0 μm, to remove alien substance such as dusts, and was stored.

<<Preparation of Organic Polyhalogen Compound-1 Dispersed Product>>

The following were sufficiently mixed to prepare a slurry: 10 kg of an organic polyhalogen compound-1 (2-tribromomethanesulfonylnaphthalene), 10 kg of a 20 mass % aqueous solution of a modified polyvinyl alcohol (Poval MP203, made by Kuraray Co., Ltd.), 0.4 kg of a 20 mass % aqueous solution of sodium triisopropylnaphthalenesulfonate, and 16 kg of water. This slurry was sent to a lateral type sand mill (UVM-2, made by Aimex Co., Ltd.), filled with zirconia beads having an average diameter of 0.5 mm, by means of a diaphragm pump, and dispersed therein for 5 hours. Subsequently, added thereto were 0.2 g of a sodium salt of benzoisothiazolinone and water, to adjust the concentration of the organic polyhalogen compound to 23.5 mass %. In this way, an organic polyhalogen compound-1 dispersed product was obtained. Organic polyhalogen compound grains contained in the thus obtained organic polyhalogen compound-1 dispersed product had a median size of 0.36 μm and a maximum grain size of 2.0 μm or less. The resultant organic polyhalogen compound-1 dispersed product was filtrated with a filter made of polypropylene and having a pore diameter of 10.0 μm, to remove alien substance such as dusts, and was stored.

<<Preparation of Organic Polyhalogen Compound-2 Dispersed Product>>

The following were sufficiently mixed to prepare a slurry: 10 kg of an organic polyhalogen compound-2(tribromomethanesulfonylbenzene), 10 kg of a 20 mass % aqueous solution of a modified polyvinyl alcohol (Poval MP203, made by Kuraray Co., Ltd.), 0.4 kg of a 20 mass % aqueous solution of sodium triisopropylnaphthalenesulfonate, and 14 kg of water. This slurry was sent to a lateral type sand mill (UVM-2, made by Aimex Co., Ltd.), filled with zirconia beads having an average diameter of 0.5 mm, by means of a diaphragm pump, and dispersed therein for 5 hours. Subsequently, added to this dispersion were 0.2 g of a sodium salt of benzoisothiazolinone and water, to adjust the concentration of the organic polyhalogen compound to 26 mass %. In this way, an organic polyhalogen compound-2 dispersed product was obtained. Organic polyhalogen compound grains contained in the thus obtained organic polyhalogen compound-2 dispersed product had a median size of 0.41 μm and a maximum grain size of 2.0 μm or less. The resultant organic polyhalogen compound-2 dispersed product was filtrated with a filter made of polypropylene and having a pore diameter of 10.0 μm, to remove alien substance such as dusts, and was stored.

<<Preparation of Phthalazine-1 Solution>>

Into 174.5 kg of water was dissolved 8 kg of modified polyvinyl alcohol (MP203, made by Kuraray Co., Ltd.). Next, to this mixture were added 3.15 kg of a 20 mass % aqueous solution of sodium triisopropylnaphthalenesulfonate and 14.28 kg of a 70 mass % aqueous solution of a phthalazine compound-1 (6-isopropylphthalazine), to prepare a 5 mass % solution of the phthalazine compound-1.

<<Preparation of Aqueous Mercapto Compound-1 Solution>>

Into 998 g of water was dissolved 7 g of a sodium salt of a mercapto compound-1 (1-(3-sulfonyl)-5-mercaptotetrazole), to prepare a 0.7 mass % aqueous solution of the compound.

<<Preparation of Pigment-1 Dispersed Product>>

To 64 g of C. I. Pigment Blue 60 and 6.4 g of Demol N made by Kao Corp. was added 250 g of water, and the resultant was sufficiently mixed to prepare a slurry. 800 g of zirconia beads having an average diameter of 0.5 mm were prepared. The beads and the slurry were put into a vessel, and they were dispersed in a dispersing machine (¼ G sand grinder mill, made by Aimex Co., Ltd.) for 25 hours, to obtain a pigment-1 dispersed product. Pigment grains contained in the thus obtained pigment-1 dispersed product had an average grain size of 0.21 μm.

<<Preparation of SBR Latex Liquid>>

An SBR latex having a Tg of 23° C. was prepared as follows.

Ammonium persulfate as a polymerization initiator and an anionic surfactant as an emulsion were used to emulsion-polymerize 70.5 parts by mass of styrene, 26.5 parts by mass of butadiene, and 3 parts by mass of acrylic acid. Thereafter, the resultant was subjected to aging at 80° C. for 8 hours, and then cooled to 40° C. The pH of the emulsion was adjusted to 7.0 with ammonia water, and thereto Sandett BL made by Sanyo Chemicals Co., Ltd. was further added in such a manner that the concentration thereof would be 0.22%. Next, a 5% aqueous sodium hydroxide solution was added thereto to adjust the pH of the emulsion liquid to 8.3. Furthermore, the pH of the emulsion was adjusted to 8.4 with ammonia water. The molar ratio between Na⁺ ions and NH₄⁺ ions used at this time was 1:2.3. Furthermore, 0.15 ml of a 7% aqueous solution of a sodium salt of benzoisothiazolinone was added to 1 kg of this emulsion liquid to prepare an SBR latex liquid.

(SBR latex: a latex of -St(70.5)-Bu(26.5)-AA(3)-)

Tg: 23° C., average grain size: 0.1 μm, concentration: 43 mass %, equilibrium water content at 25° C. and 60% RH: 0.6 mass %, ion conductivity: 4.2 mS/cm (a conductivity meter CM-30S made by Toa Denpa Kougyou Co., Ltd. was used to measure the ion conductivity of the latex undiluted liquid (43 mass %) at 25° C.), and pH: 8.4.

SBR latexes having different Tg's were prepared in the same manner except that the ratio between styrene and butadiene was appropriately changed.

<<Preparation of Emulsion Layer (Photosensitive Layer) Coating Liquid>>

To 1000 g of the organic silver salt dispersed product obtained in the above-mentioned steps were successively added: 125 ml of water, 113 g of the reducing agent-1 dispersed product, 91 g of the reducing agent-2 dispersed product, 27 g of the pigment-1 dispersed product, 82 g of the organic polyhalogen compound-1 dispersed product, 40 g of the organic polyhalogen compound-2 dispersed product, 173 g of the phthalazine compound-1 solution, 1082 g of the SBR latex (Tg: 20.5° C.) liquid, and 9 g of the aqueous mercapto compound-1 solution. Immediately before coating, 158 g of the silver halide mixed emulsion A was added thereto for a coating liquid, and the emulsion layer coating liquid sufficiently mixed was sent to a coating die, and applied.

The viscosity of the emulsion layer coating liquid was measured with a B type viscometer made of Tokyo Keiki Co. This viscosity was 85 mPa·s at 40° C. (No. 1 rotor, 60 rpm).

According to an RFS fluid spectrometer made by Leometrics Far East Co., Ltd, the viscosities at 25° C. were 1500, 220, 70, 40 and 20 mPa·s at shear speeds of 0.1, 1, 10, 100 and 1000 1/sec., respectively.

<<Preparation of EmulsionFace Intermediate Layer Coating Liquid>>

To 772 g of a 10 mass % aqueous solution of polyvinyl alcohol PVA-205 (made by Kuraray Co., Ltd.), 5.3 g of a 20 mass % dispersed product of a pigment, and 226 g of a latex of methyl methacrylate/styrene/butylacrylate/hydroxyethylacrylate/acrylic acid copolymer (weight ratio: 64/9/20/5/2) were added 2 ml of a 5 mass % aqueous solution of Aerosol OT (made by American Sianamide Co.) and 10.5 ml of a 20 mass % aqueous solution of diammonium phthalate. Furthermore, water was added thereto in such a manner that the total amount would be 880 g. The pH of the solution was adjusted to 7.5 with NaOH to prepare an intermediate layer coating liquid. The solution was sent to a coating die to give a coating amount of 10 ml/m².

The viscosity of the coating liquid was 21 mPa·s at 40° C. according to the B type viscometer (No. 1 rotor, 60 rpm).

<<Preparation of Emulsion-Face First Protective Layer Coating Liquid>>

Into water was dissolved 64 g of inert gelatin, and thereto were added 80 g of a 27.5 mass % latex liquid of methyl methacrylate/styrene/butylmethacrylate/hydroxyethyl acrylate/acrylic acid copolymer (weight ratio: 64/9/20/5/2), 23 ml of a 10 mass % solution of phthalic acid in methanol, 23 ml of a 10 mass % solution of 4-methyl phthalic acid, 28 ml of sulfuric acid having a concentration of 0.5 mole/L, 5 ml of a 5 mass % aqueous solution of Aerosol OT (made by American Sianamide Co.), 0.5 g of phenoxyethanol, and 0.1 g of benzoisothiazolinone. water was added thereto in such a manner that the total amount would be 750 g. In this way, a coating liquid was prepared. Immediately before coating, 26 ml of 4 mass % chromium alum was mixed with the coating liquid with a static mixer. The mixture was sent to a coating die to give a coating amount of 18.6 ml/m².

The viscosity of the coating liquid was 17 mPa·s at 40° C. according to the B type viscometer (No. 1 rotor, 60 rpm).

<<Preparation of Emulsion-Face Second Protective Layer Coating Liquid>>

Into water was dissolved 80 g of inert gelatin, and to this were added 102 g of a 27.5 mass % latex liquid of methyl methacrylate/styrene/butylacrylate/hydroxyethyl methacrylate/acrylic acid copolymer (weight ratio: 64/9/20/5/2), 3.2 ml of a 5 mass % solution of a fluorinated surfactant (F-1: a potassium salt of N-perfluorooctylsulfonyl-N-propylalanine, 32 ml of a 2 mass % aqueous solution of a fluorinated surfactant (F-2: polyethylene glycol mono(N-perfluorooctylsulfonyl-N-propyl-2-aminoethyl) ether [ethylene oxide average polymerization degree=15], 23 ml of a 5 mass % aqueous solution of Aerosol OT (made by American Sianamide Co.), 4 g of polymethyl methacrylate fine grains (average grain size: 0.7 μm), 21 g of polymethyl methacrylate fine grains (average grain size: 4.5 μm), 1.6 g of 4-methylphthalic acid, 4.8 g of phthalic acid, 44 ml of sulfuric acid having a concentration of 0.5 mole/L, and 10 mg of benzoisothiazolinone. To this mixture was added water in such a manner that the total amount would be 650 g. Immediately before coating, 445 ml of an aqueous solution containing 4 mass % chromium alum and 0.67 mass % of phthalic acid was mixed with the coating liquid with a static mixer. The mixture was used as a surface protective layer coating liquid and sent to a coating die to give a coating amount of 8.3 ml/m².

The viscosity of the coating liquid was 9 mPa·s at 40° C. according to the B type viscometer (No. 1 rotor, 60 rpm).

<<Production of Heat-Developable Photosensitive Materials-1 to -12>>

The antihalation layer coating liquid and the back face protective layer coating liquid were simultaneously applied, in the form of overlapped layers, to the back face of each of the undercoated supports A to L. The antihalation layer coating liquid was applied in such a manner that the solid content coating amount of the solid fine grain dye would be 0.04 g/m², and the back face protective layer coating liquid was applied in such a manner that the gelatin coating amount would be 1.7 g/m². The applied solutions were dried to produce a back layer.

The emulsion layer (photosensitive layer) coating liquid, the intermediate coating liquid, the first protective layer coating liquid and the second protective layer coating liquid were applied, in this order when viewed from the undercoat face and in the form of overlapped layers, to the face opposite to the back face in a slide bead coating manner at the same time. In this way, each of heat-developable photosensitive materials-1 to -12 was produced. At this time, the temperature of the emulsion layer and the intermediate layer was adjusted to 31° C., the temperature of the first protective layer was adjusted to 36° C., and the temperature of the second protective layer was adjusted to 37° C.

The coating amounts (g/m²) of the respective compounds in the emulsion layers were as follows.

| | |
|---|---|
| silver behenate (organic silver salt) | 6.19 |
| reducing agent-1 | 0.67 |
| reducing agent-2 | 0.54 |
| pigment (C. I. Pigment blue 60) | 0.032 |
| organic polyhalogen compound-1 | 0.46 |
| organic polyhalogen compound-2 | 0.25 |
| phthalazine compound-1 | 0.21 |
| SBR latex | 11.1 |
| mercapto compound-1 | 0.002 |
| silver halide (as Ag) | 0.145 |

Coating and drying conditions were as follows.

The coating was performed at a speed of 160 m/min. A gap between the tip of the coating die and the support was set to be from 0.10 to 0.30 mm. A pressure in a reducing chamber was set to be from 196 to 882 Pa lower than the atmospheric pressure. The support was subjected to electricity-removing treatment by ion-wind before coating.

Subsequently, in a chilling zone, the coating liquid was cooled with window having a dry bulb temperature of 10 to 20° C. Thereafter, the support was carried in a non-contacting manner, and dried by dry wind having a dry bulb temperature of 23 to 45° C. and a wet bulb temperature of 15 to 21° C. in a tendril type non-contact drying machine.

After the drying, the humidity was adjusted to 40 to 60% RH at 25° C. Thereafter, the support was heated in such a manner that its film face would be from 70 to 90° C. After the heating, the film face was cooled to 25° C.

About the mat degree of the produced heat-developable photosensitive material, the Beck smoothness thereof was 55 seconds on the side of the photosensitive layer face, and was 130 seconds on the side of the back face. The pH of the film face on the side of the photosensitive layer was measured. As a result, the pH was 6.0.

Chemical structures of the compounds used in the examples of the invention will be illustrated below.

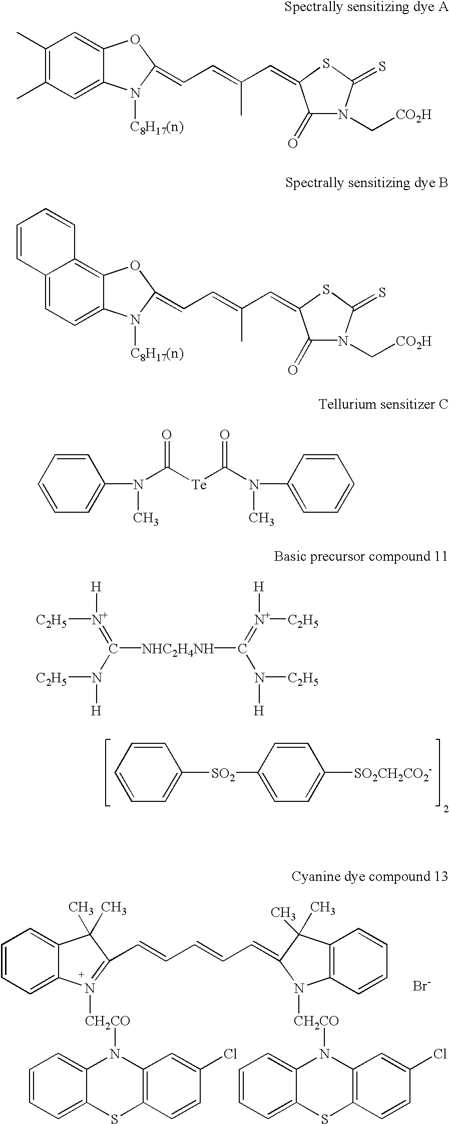

### Example 1

Evaluation of Undercoat Layers in the Undercoated Supports A to H

Measurements and evaluations for the undercoated supports A to H produced as described above were made by the following methods.

<Evaluation of Cissing Defects>

The number of cissing defects generated per m² of the undercoat layer in each of the undercoated supports A to D was measured with the naked eye. The measurement results are shown in Table 2.

The cissing defect means a condition that the undercoat layer is dried in a state that the solution is repelled around a central alien substance so that a crater form is locally generated.

<Evaluation of Streak Defects>

The number of streak defects generated per m² of the undercoat layer in each of the undercoated supports E to H was measured with the naked eye. The measurement results are shown in Table 2.

TABLE 2

| | Cleanliness | Cleanliness | | The Number | |
|---|---|---|---|---|---|
| Undercoated | Class (based | Class (based | Evaluation | of Generated | |
| Support | on meters | on feet | Item | Defects | Remarks |
| A | M4.80 | 1800 | Cissings | 0 | The invention |
| B | M5.24 | 4900 | Cissings | 5 | The invention |
| C | M5.45 | 8000 | Cissings | 20 | The invention |
| D | M5.72 | 15000 | Cissings | 100 | Comparative |
| | | | | | Example |
| E | M4.72 | 1500 | Streaks | 0 | The invention |
| F | M5.13 | 3800 | Streaks | 2 | The invention |
| G | M5.26 | 5200 | Streaks | 10 | The invention |
| H | M5.53 | 9700 | Streaks | 20 | Comparative |
| | | | | | Example |

It was verified from the results in Table 2 that in the undercoat layers used in the heat-developable photosensitive materials of the invention, both the number of generated cissing defect and the number of generated streak defects were small and these undercoat layers were high-quality undercoat layers suitable for forming a heat-developable photosensitive layer in the next step.

### Example 2

Evaluations of Heat-Developable Photosensitive Materials 1 to 12

Cissing defects and streak defects for heat-developable photosensitive materials 1 to 12 were measured and evaluated by the same methods as in Example 1, and further black spot defects were measured and evaluated by the following method.

<Evaluation of Black Spot Defects>

The number of black spot defects generated per m² of the undercoat layer in each of the heat-developable photosensitive materials 9 to 12 was measured with the naked eye.

The back spot defect means the following state: after the formation of the undercoat layer an alien substance adheres to the surface of the layer and the substance is taken in the photosensitive layer at the time of coating in the second step; thus, when light penetrates into the photosensitive layer, a blacker alien substance (spot having a larger density) than normal portions is locally observed.

The evaluation results of the cissing defects, the streak defects and the black spot defects are shown in Table 3.

TABLE 3

| Heat- | | | | | |
|---|---|---|---|---|---|
| Developable | Cleanliness | Cleanliness | | The Number | |
| Photosensitive | Class (based | Class (based | Evaluation | of Generated | |
| Material | on meters) | on feet) | Item | Defects | Remarks |
| 1 | M4.80 | 1800 | Cissings | 0 | The |
| | | | | | invention |
| 2 | M5.24 | 4900 | Cissings | 5 | The |
| | | | | | invention |
| 3 | M5.45 | 8000 | Cissings | 20 | The |
| | | | | | invention |
| 4 | M5.72 | 15000 | Cissings | 100 | Comparative |
| | | | | | Example |
| 5 | M4.72 | 1500 | Streaks | 0 | The |
| | | | | | invention |
| 6 | M5.13 | 3800 | Streaks | 2 | The |
| | | | | | invention |
| 7 | M5.26 | 5200 | Streaks | 10 | The |
| | | | | | invention |
| 8 | M5.53 | 9700 | Streaks | 20 | Comparative |
| | | | | | Example |
| 9 | M4.63 | 1200 | Block spots | 0 | The |
| | | | | | invention |
| 10 | M5.08 | 3400 | Block spots | 3 | The |
| | | | | | invention |
| 11 | M5.29 | 5500 | Block spots | 15 | The |
| | | | | | invention |
| 12 | M5.56 | 10200 | Block spots | 50 | Comparative |
| | | | | | Example |

It was verified from the results in Table 3 that by reducing dust in the undercoating step, cissing defects and streak defects, which are generated in the undercoat layer and produce an effect on the heat-developable photosensitive layer, were markedly overcome and further black spot defects, wherein source substances in the undercoating step result in defects in the heat-developable photosensitive layer, were similarly overcome.

According to the invention, it is possible to provide a high-quality heat-developable photosensitive material wherein the following defects are not generated: cissing defects and streak defects, which result from dust in a process atmosphere when an undercoat layer is formed on a support, or black spot defects, which become apparent when a photosensitive layer is formed; and a method of producing the photosensitive material.

What is claimed is:

1. A heat-developable photosensitive material comprising:
a support;
an undercoat layer disposed on the support and formed in an atmosphere having a cleanliness class of no more than M5.45; and
a photosensitive layer including silver behenate as a non-photosensitive organic silver salt and disposed on the undercoat layer.

2. The heat-developable photosensitive material according to claim 1, wherein the cleanliness class is no more than M5.25.

3. The heat-developable photosensitive material according to claim 1, wherein the cleanliness class is no more than M5.15.

4. The heat-developable photosensitive material according to claim 1, wherein the undercoat layer comprises a surface resistance (SR), the surface resistance being from 10⁶ to 10¹² Ω·cm.

5. The heat-developable photosensitive material according to claim 1, wherein the undercoat layer includes at least one binder resin selected from the group consisting of acrylic resins, polyester resins, polyurethane resins, polystyrene resins, SBR resins and PVDC (polyvinyl dichloride) resins.

6. The heat-developable photosensitive material according to claim 1, wherein the undercoat layer includes at least one conductive particle selected from the group consisting of tin oxide, indium oxide, zinc oxide, aluminum oxide and titanium oxide.

7. The heat-developable photosensitive material according to claim 6, wherein the conductive particle comprises a conductive tin oxide particle doped with antimony having a needle-shaped structure including a long axis and a short axis, and a ratio of the long axis of the particle to the short axis ranges from 3 to 50.

8. The heat-developable photosensitive material according to claim 1, wherein the undercoat layer includes at least one crosslinking agent selected from the group consisting of epoxy compounds, isocyanate compounds, melamine compounds, and active halogen compounds.

9. The heat-developable photosensitive material according to claim 1, wherein the undercoat layer comprises at least one matting agent selected from the group consisting of styrene fine particles, polymethyl methacrylate fine particles, and silica fine particles, and the average particle diameter of the matting agent ranges from 0.1 to 8 μm.

10. The heat-developable photosensitive material according to claim 9, wherein an amount of the matting agent used comprises from 1 to 200 mg per m² of the heat-developable photosensitive material.

11. The heat-developable photosensitive material according to claim 1, wherein the thickness of the undercoat layer comprises from 0.05 to 5 μm.

12. The heat-developable photosensitive material according to claim 1, wherein the photosensitive layer further includes a photosensitive silver halide, a non-photosensitive organic silver salt, a reducing agent for silver ions, and a binder.

13. The heat-developable photosensitive material according to claim 12, wherein the photosensitive silver halide includes at least one selected from the group consisting of silver chloride, silver chlorobromide, silver bromide, silver iodobromide, and silver iodochlorobromide.

14. The heat-developable photosensitive material according to claim 12, wherein a coated amount of the photosensitive silver halide, expressed as an amount of silver per m² of the heat-developable photosensitive material, comprises from 0.03 to 0.6 g/m².

15. The heat-developable photosensitive material according to claim 12, wherein the non-photosensitive organic silver salt includes not only the silver behenate but also at least one selected from the group consisting of silver arachidate, silver stearate, silver oleate, silver laurate, silver caprate, silver myristate, and silver palmitate.

16. The heat-developable photosensitive material according to claim 1, wherein an amount of the silver behenate in the non-photosensitive organic silver salt in the photosensitive layer comprises at least 75% by mole.

17. The heat-developable photosensitive material according to claim 1, wherein a total amount, as a silver amount, of the non-photosensitive organic silver salt used comprises from 0.1 to 5 g/m².

18. The heat-developable photosensitive material according to claim 12, wherein the reducing agent for the silver ions comprises at least one selected from hindered phenol-based reducing agents and bisphenol-based reducing agents.

19. The heat-developable photosensitive material according to claim 12, wherein an amount of the reducing agent for the silver ions added comprises from 0.01 to 5.0 g/m².

20. The heat-developable photosensitive material according to claim 12, wherein the glass transition temperature of the binder comprises from 10° C. to 80° C.

21. The heat-developable photosensitive material according to claim 1, further comprising a surface protecting layer and a back layer.

22. A method of producing a heat-developable photosensitive material comprising the steps of:
forming an undercoat layer by applying a coating liquid for the undercoat layer to a support and drying the liquid;
forming a photosensitive layer by applying a coating liquid for the photosensitive layer, which coating liquid includes silver behenate, and drying the liquid;
wherein the undercoat layer is formed in an atmosphere having a cleanliness class of no more than M5.45.

23. The method according to claim 22, wherein the coating liquid for the undercoat layer comprises an aqueous coating liquid including at least one of a solvent comprising at least 30% by mass of water and a dispersing medium comprising at least 30% by mass of water.

24. The method according to claim 22, wherein in the undercoat layer forming step, after the coating liquid for the undercoat layer is applied, the liquid is dried at a temperature of 25 to 200° C. for 0.5 to 20 minutes.
